(19) United States
(12) Patent Application Publication
(10) Pub. No.: US 2016/0026604 A1
(43) Pub. Date: Jan. 28, 2016

(54) DYNAMIC RDMA QUEUE ON-LOADING

(71) Applicant: Emulex Corporation, Costa Mesa, CA (US)

(72) Inventors: Parav K. Pandit, Bangalore (IN); Masoodur Rahman, Austin, TX (US)

(21) Appl. No.: 14/536,494

(22) Filed: Nov. 7, 2014

Related U.S. Application Data
(60) Provisional application No. 62/030,057, filed on Jul. 28, 2014.

(51) Int. Cl. G06F 15/167; H04L 12/06

(52) U.S. Cl. CPC G06F 15/167; H04L 12/06

(57) ABSTRACT

A remote direct memory access (RDMA) host device having a host operating system and an RDMA network communication adapter device. Responsive to determination of an RDMA on-load event for an RDMA queue used in an RDMA connection, at least one of a user-mode module and the operating system of the host device is used to provide an RDMA on-load notification to the RDMA network communication adapter device. The on-load notification notifies the adapter device of the determination of the on-load event for the RDMA queue, and the determination is performed by at least one of the user-mode module and the operating system. During processing of an RDMA transaction of the RDMA queue in a case where the RDMA on-load event is determined, the operating system is used to perform at least one RDMA sub-process of the RDMA transaction.

### CROSS REFERENCE

This patent application claims the benefit of U.S. Provisional Patent Application No. 62/030,057 entitled REGISTRATIONLESS TRANSMIT ONLOAD RDMA filed on Jul. 28, 2014 by inventors Parav K. Pandit, and Masoodur Rahman.

### FIELD

The present disclosure relates to remote direct memory access (RDMA).

### BACKGROUND

Direct memory access (DMA) is a feature of computers that allows certain hardware subsystems within the computer to access system memory independently of the central processing unit (CPU). Remote direct memory access (RDMA) is a direct memory access (DMA) of a memory of a remote computer, typically without involving either computer's operating system.

For example, a network communication adapter device of a first computer can use DMA to read data in a user-specified buffer in a main memory of the first computer and transmit the data as a self-contained message across a network to a receiving network communication adapter device of a second computer. The receiving network communication adapter device can use DMA to place the data into a user-specified buffer of a main memory of the second computer. This remote DMA process can occur without intermediary copying and without involvement of CPUs of the first computer and the second computer.

### SUMMARY

Embodiments disclosed herein are summarized by the claims that follow below. However, this brief summary is being provided so that the nature of this disclosure may be understood quickly.

Typical remote direct memory access (RDMA) systems include fully off-loaded RDMA systems in which the adapter device performs all stateful RDMA processing, and fully on-loaded RDMA systems in which the computer's operating system performs all stateful RDMA processing. There is a need for more flexible RDMA systems that can be dynamically configured to perform RDMA processing by using either the adapter device or the operating system or a combination of both.

This need is addressed by an RDMA host device having a host operating system and an RDMA network communication adapter device in which the operating system controls selective on-loading and off-loading of processing for an RDMA transaction of a designated RDMA queue. The operating system performs on-loaded processing and the adapter device performs off-loaded processing. The operating system can control the selective on-loading and off-loading based on RDMA Verb parameters, system events, and system environment state such as properties of an application associated with the RDMA transaction, network traffic properties, properties of packets transmitted by the adapter device, and properties of packets received by the adapter device. The adapter device provides on-loading of processing for the designated RDMA queue by moving context information from a memory of the adapter device to a main memory of the host device and changing ownership of the context information from the adapter device to the operating system. The adapter device provides off-loading of processing for the designated RDMA queue by moving context information from the main memory of the host device to the memory of the adapter device and changing ownership of the context information from the operating system to the adapter device. The context information of the RDMA queue can include at least one of signaling journals, acknowledgement (ACK) timers for the RDMA queue, PSN information, incoming read context, outgoing read context and other state information related to protocol processing.

In an example embodiment, a remote direct memory access (RDMA) host device has a host operating system and an RDMA network communication adapter device. Responsive to determination of an RDMA on-load event for an RDMA queue used in an RDMA connection, at least one of a user-mode module and the operating system of the host device is used to provide an RDMA on-load notification to the RDMA network communication adapter device. The on-load notification notifies the adapter device of the determination of the on-load event for the RDMA queue, and the determination is performed by at least one of the user-mode module and the operating system. During processing of an RDMA transaction of the RDMA queue in a case where the RDMA on-load event is determined, the operating system is used to perform at least one RDMA sub-process of the RDMA transaction.

According to aspects, the RDMA queue is at least one of a send queue (SQ) and a receive queue (RQ) of an RDMA Queue Pair (QP), the RDMA transaction includes at least one of an RDMA transmission and an RDMA reception, and the RDMA connection is at least one of a reliable connection (RC) and an unreliable connection (UC). The at least one of the user-mode module and the operating system determines the on-load event for the RDMA queue based on at least one of parameters provided during creation of the RDMA queue, operating system events, adapter device events, properties of an application associated with the RDMA transaction, network traffic properties, properties of packets transmitted by the network communication adapter device, and properties of packets received by the network communication adapter device. At least one of the user-mode module and the operating system provides the RDMA on-load notification via at least one of an interrupt and an RDMA Work Request.

According to further aspects, responsive to the RDMA on-load notification, the adapter device moves context information for the RDMA queue from a memory of the adapter device to a main memory of the host device and changes ownership of the context information from the adapter device to the operating system. In the case where the RDMA on-load event is determined, the operating system performs the at least one RDMA sub-process based on the context information.

According to an aspect, the context information of the RDMA queue includes at least one of signaling journals, ACK timers for the RDMA queue, PSN information, incoming read context, outgoing read context and other state information related to protocol processing.

According to another aspect, responsive to determination of an RDMA off-load event for the RDMA queue, at least one of the user-mode module and the operating system is used to provide an RDMA off-load notification to the adapter device. The off-load notification notifies the adapter device of the determination of the off-load event for the RDMA queue. At least one of the user-mode module and the operating system performs the determination. During processing of the RDMA transaction of the RDMA queue in a case where the RDMA off-load event is determined, the adapter device is used to perform the at least one RDMA sub-process. At least one of the user-mode module and the operating system determines the off-load event for the RDMA queue based on at least one of: parameters provided during creation of the RDMA queue, operating system events, adapter device events, properties of an application associated with the RDMA transaction, network traffic properties, properties of packets transmitted by the network communication adapter device, and/or properties of packets received by the network communication adapter device. At least one of the user-mode module and the operating system provides the RDMA off-load notification via at least one of an interrupt and an RDMA Work Request.

According to further aspects, responsive to the RDMA off-load notification, the adapter device moves context information for the RDMA queue from a main memory of the host device to a memory of the adapter device and changes ownership of the context information from the operating system to the adapter device. In the case where the RDMA off-load event is determined, the adapter device performs the at least one RDMA sub-process based on the context information.

### BRIEF DESCRIPTION OF THE DRAWINGS

The following is a brief description of the drawings, in which like reference numbers may indicate similar elements.

FIG. 1A is a block diagram depicting an exemplary computer networking system with a data center network system having a remote direct memory access (RDMA) communication network, according to an example embodiment.

FIG. 1B is a diagram depicting an exemplary RDMA system, according to an example embodiment.

FIG. 2 is a diagram depicting on-loading of send queue processing and receive queue processing for an RDMA queue pair, according to an example embodiment.

FIG. 3 is a diagram depicting an exemplary structure of a work request element for an RDMA reception work request, according to an example embodiment.

FIG. 4 is a diagram depicting an exemplary structure of a work request element for an RDMA transmission work request, according to an example embodiment.

FIG. 5 is a diagram depicting reception of a packet in a case where send queue processing and receive queue processing for a queue pair is on-loaded, according to an example embodiment.

FIG. 6 is a diagram depicting reception of a read response packet in a case where send queue processing and receive queue processing for a queue pair is on-loaded, according to an example embodiment.

FIG. 7 is a diagram depicting reception of a send packet in a case where send queue processing and receive queue processing for a queue pair is on-loaded, according to an example embodiment.

FIG. 8 is a diagram depicting reception of a RDMA write packet in a case where send queue processing and receive queue processing for a queue pair is on-loaded, according to an example embodiment.

FIG. 9 is a diagram depicting reception of a RDMA read packet in a case where send queue processing and receive queue processing for a queue pair is on-loaded, according to an example embodiment.

FIG. 10 is a diagram depicting off-loading of receive queue processing for a queue pair while send queue processing for the queue pair remains on-loaded, according to an example embodiment.

FIG. 11 is a diagram depicting off-loading of send queue processing for a queue pair while receive queue processing for the queue pair remains off-loaded, according to an example embodiment.

FIG. 12 is a diagram depicting on-loading of receive queue processing for a queue pair while send queue processing for the queue pair remains off-loaded, according to an example embodiment.

FIG. 13 is an architecture diagram of an RDMA system, according to an example embodiment.

FIG. 14 is an architecture diagram of an RDMA network adapter device, according to an example embodiment.

### DETAILED DESCRIPTION

In the following detailed description, numerous specific details are set forth in order to provide a thorough understanding. However, it will be obvious to one skilled in the art that the embodiments may be practiced without these specific details. In other instances well known methods, procedures, and components have not been described in detail so as not to unnecessarily obscure aspects of the embodiments described herein.

Methods, non-transitory machine-readable storage media, apparatuses, and systems are disclosed that provide remote direct memory access (RDMA).

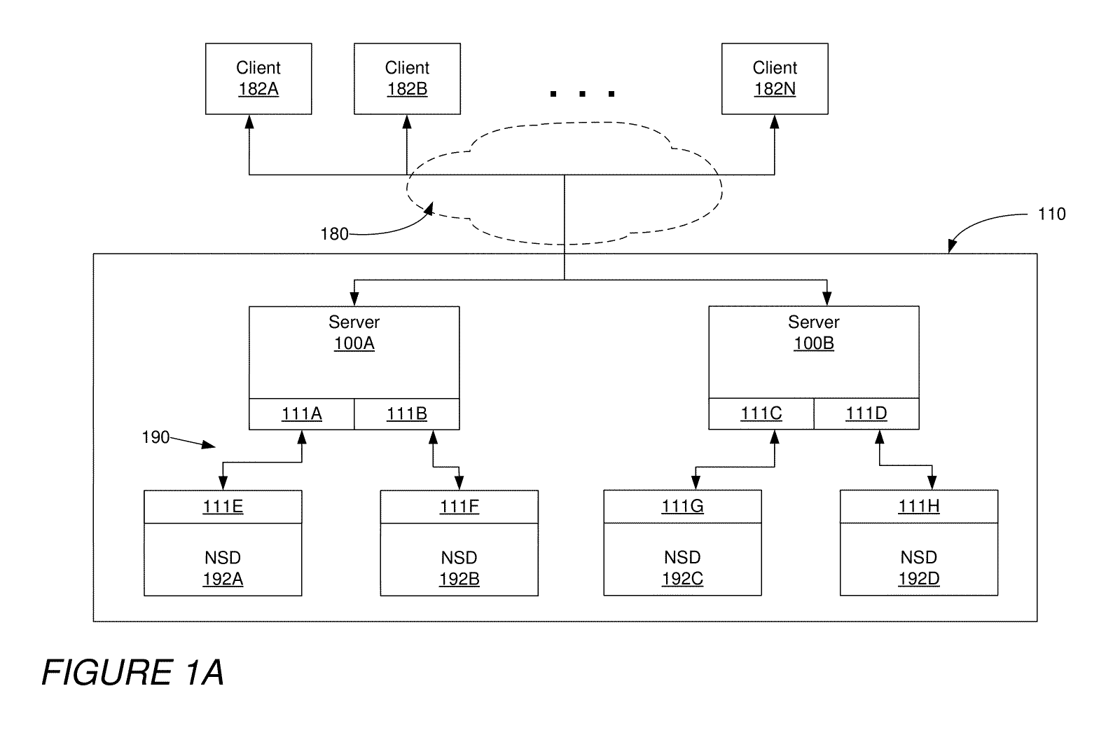

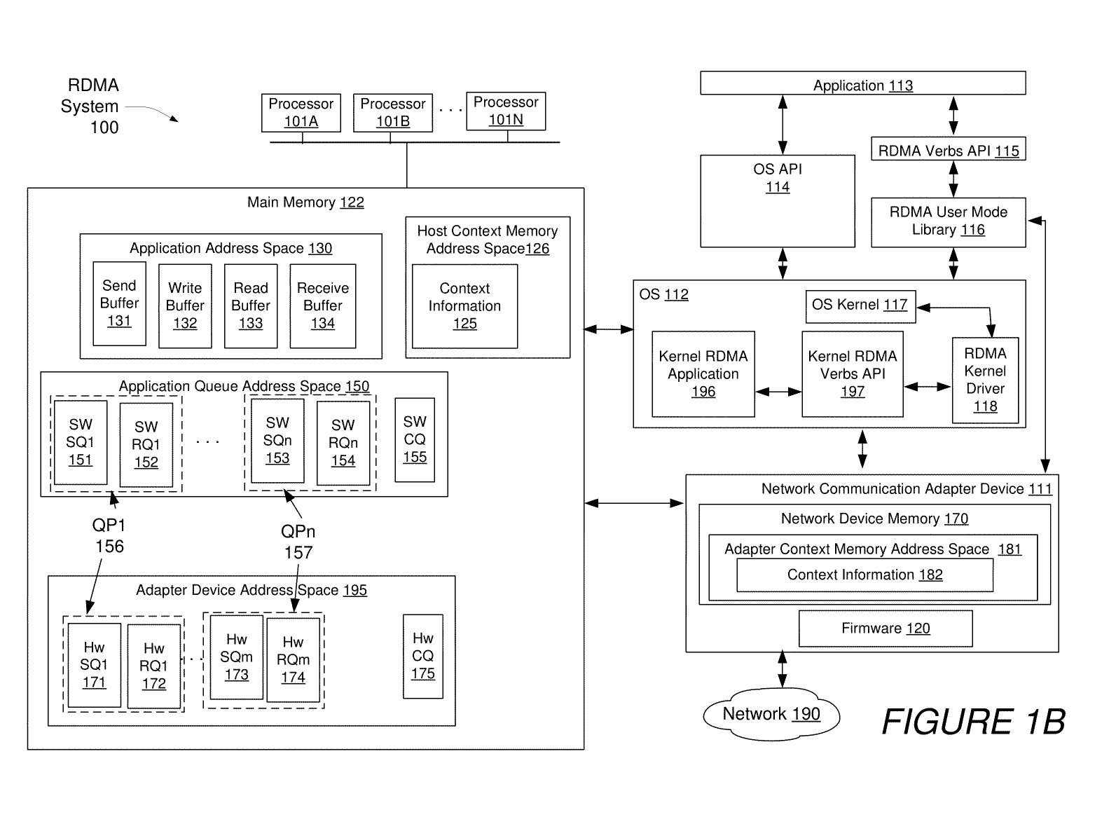

Referring now to FIG. 1A, a block diagram illustrates an exemplary computer networking system with a data center network system 110 having an RDMA communication network 190. One or more remote client computers 182A-182N may be coupled in communication with the one or more servers 100A-100B of the data center network system 110 by a wide area network (WAN) 180, such as the world wide web (WWW) or internet.

The data center network system 110 includes one or more server devices 100A-100B and one or more network storage devices (NSD) 192A-192D coupled in communication together by the RDMA communication network 190. RDMA message packets are communicated over wires or cables of the RDMA communication network 190 the one or more server devices 100A-100B and the one or more network storage devices (NSD) 192A-192D. To support the communication of RDMA message packets, the one or more servers 100A-100B may each include one or more RDMA network interface controllers (RNICs) 111A-111B,111C-111D (sometimes referred to as RDMA host channel adapters), also referred to herein as network communication adapter device(s) 111.

To support the communication of RDMA message packets, each of the one or more network storage devices (NSD) 192A-192D includes at least one RDMA network interface controller (RNIC) 111E-111H, respectively. Each of the one or more network storage devices (NSD) 192A-192D includes a storage capacity of one or more storage devices (e.g., hard disk drive, solid state drive, optical drive) that can store data. The data stored in the storage devices of each of the one or more network storage devices (NSD) 192A-192D may be accessed by RDMA aware software applications, such as a database application. A client computer may optionally include an RDMA network interface controller (not shown in FIG. 1A) and execute RDMA aware software applications to communicate RDMA message packets with the network storage devices 192A-192D.

Referring now to FIG. 1B, a block diagram illustrates an exemplary RDMA system 100 that can be instantiated as the server devices 100A-100B of the data center network 110. In the example embodiment, the RDMA system 100 is a server device. In some embodiments, the RDMA system 100 can be any other suitable type of RDMA system, such as, for example, a client device, a network device, a storage device, a mobile device, a smart appliance, a wearable device, a medical device, a sensor device, a vehicle, and the like.

The RDMA system 100 is an exemplary RDMA-enabled information processing apparatus that is configured for RDMA communication to transmit and/or receive RDMA message packets. The RDMA system 100 includes a plurality of processors 101A-101N, a network communication adapter device 111, and a main memory 122 coupled together. One of the processors 101A-101N is designated a master processor to execute instructions of an operating system (OS) 112, an application 113, an Operating System API 114, a user RDMA Verbs API 115, and an RDMA user-mode library 116 (a user-mode module). The OS 112 includes software instructions of an OS kernel 117, an RDMA kernel driver 118, a Kernel RDMA application 196, and a Kernel RDMA Verbs API 197.

The main memory 122 includes an application address space 130, an application queue address space 150, a host context memory (HCM) address space 126, and an adapter device address space 195. The application address space 130 is accessible by user-space processes. The application queue address space 150 is accessible by user-space and kernel-space processes. The adapter device address space 195 is accessible by user-space and kernel-space processes and the adapter device firmware 120.

The application address space 130 includes buffers 131 to 134 used by the application 113 for RDMA transactions. The buffers include a send buffer 131, a write buffer 132, a read buffer 133 and a receive buffer 134.

The host context memory (HCM) address space 126 includes context information 125.

As shown in FIG. 1B, the RDMA system 100 includes two queue pairs, the queue pair (QP) 156 and the queue pair (QP) 157.

The queue pair 156 includes a software send queue (SWSQ1) 151, an adapter device send queue (HWSQ1) 171, a software receive queue (SWRQ1) 152, and an adapter device receive queue (HWRQ1) 172. In the example implementation, the software RDMA completion queue (CP) (SWCQ) 155 is used in connection with the software send queue 151 and the software receive queue 152. In the example implementation, the adapter device RDMA completion queue (CP) (HWCQ) 175 is used in connection with the adapter device send queue 171 and the adapter device receive queue 172.

In a case where send queue processing of the queue pair 156 is on-loaded, the software send queue 151 of the queue pair 156 is used for stateful processing and is accessible by the RDMA user-mode library 116 and the RDMA kernel driver 118, while the adapter device send queue 171 is not used for stateful processing. In a case where send queue processing of the queue pair 156 is off-loaded, the software send queue 151 of the queue pair 156 is not used for stateful processing, while the adapter device send queue 171 is used for stateful processing and is accessible by the RDMA user-mode library 116 and the firmware 120. In the example implementation, in the case where send queue processing of the queue pair 156 is off-loaded, the RDMA user-mode library 116 communicates with the adapter device 111 directly without using the RDMA kernel driver 118. In a case where receive queue processing of the queue pair 156 is on-loaded, the software receive queue 152 of the queue pair 156 is used for stateful processing and is accessible by the RDMA user-mode library 116 and the RDMA kernel driver 118, while the adapter device receive queue 172 is not used for stateful processing. In a case where receive queue processing of the queue pair 156 is off-loaded, the software receive queue 152 of the queue pair 156 is not used for stateful processing, while the adapter device receive queue 172 is used for stateful processing and is accessible by the RDMA user-mode library 116 and the firmware 120. In the example implementation, in the case where receive queue processing of the queue pair 156 is off-loaded, the RDMA user-mode library 116 communicates with the adapter device 111 directly without using the RDMA kernel driver 118.

Similarly, the queue pair 157 includes a software send queue (SWSQn) 153, an adapter device send queue (HWSQm) 173, a software receive queue (SWRQn) 154, and an adapter device receive queue (HWRQm) 174. In a case where send queue processing of the queue pair 157 is on-loaded, the software send queue 153 of the queue pair 157 is used for stateful processing and is accessible by the RDMA user-mode library 116 and the RDMA kernel driver 118, while the adapter device send queue 173 is not used for stateful processing. In a case where send queue processing of the queue pair 157 is off-loaded, the software send queue 153 of the queue pair 157 is not used for stateful processing, while the adapter device send queue 173 is used for stateful processing and is accessible by the RDMA user-mode library 116 and the firmware 120. In the example implementation, in the case where send queue processing of the queue pair 157 is off-loaded, the RDMA user-mode library 116 communicates with the adapter device 111 directly without using the RDMA kernel driver 118. In a case where receive queue processing of the queue pair 157 is on-loaded, the software receive queue 154 of the queue pair 157 is used for stateful processing and is accessible by the RDMA user-mode library 116 and the RDMA kernel driver 118, while the adapter device receive queue 174 is not used for stateful processing. In a case where receive queue processing of the queue pair 157 is off-loaded, the software receive queue 154 of the queue pair 157 is not used for stateful processing, while the adapter device receive queue 174 is used for stateful processing and is accessible by the RDMA user-mode library 116 and the firmware 120. In the example implementation, in the case where receive queue processing of the queue pair 157 is off-loaded, the RDMA user-mode library 116 communicates with the adapter device 111 directly without using the RDMA kernel driver 118.

In the example implementation, the application 113 creates the queue pairs 156 and 157 by using the RDMA verbs application programming interface (API) 115 and the RDMA user mode library 116. During creation of the queue pair 156, the RDMA user mode library 116 creates the software send queue 151 and the software receive queue 152 in the application queue address space 150, and creates the adapter device send queue 171 and the adapter device receive queue 172 in the adapter device address space 195. Once created, the RDMA queues 151 to 155 reside in un-locked (unpinned) memory pages.

In an example implementation, in a case where processing (e.g., one or more of send queue and receive queue processing) of a queue pair (e.g., QP 156, 157) is on-loaded, the operating system 112 maintains a state of the queue pair (e.g., in the context information 125). In the case of on-loaded send queue processing for a queue pair, the operating system 112 also maintains a state in connection with processing of work requests stored in the send queue (e.g., send queues 151 and 153) of the queue pair.

The network device memory 170 includes an adapter context memory (ACM) address space 181. The adapter context memory (ACM) address space 181 includes context information 182.

In an example implementation, in a case where processing (e.g., one or more of send queue and receive queue processing) of a queue pair (e.g., QP 156, 157) is off-loaded, the adapter device 111 maintains a state of the queue pair in the context information 182. In the case of off-loaded send queue processing for a queue pair, the adapter device 111 also maintains a state in connection with processing of work requests stored in the send queue (e.g., send queues 171 and 173) of the queue pair.

In the example implementation, the RDMA verbs API 115, the RDMA user-mode library 116, the RDMA kernel driver 118, and the network device firmware 120 provide RDMA functionality in accordance with the INIFNIBAND Architecture (IBA) specification (e.g., INIFNIBAND Architecture Specification Volume 1, Release 1.2.1 and Supplement to INIFNIBAND Architecture Specification Volume 1, Release 1.2.1-RoCE Annex A16, which are incorporated by reference herein).

The RDMA verbs API 115 implements RDMA verbs, the interface to an RDMA enabled network interface controller. The RDMA verbs can be used by user-space applications to invoke RDMA functionality. The RDMA verbs typically provide access to RDMA queuing and memory management resources, as well as underlying network layers.

In the example implementation, the RDMA verbs provided by the RDMA Verbs API 115 are RDMA verbs that are defined in the INIFNIBAND Architecture (IBA) specification. RDMA verbs include the following verbs which are described herein: Create Queue Pair, Post Send Request, and Register Memory Region.

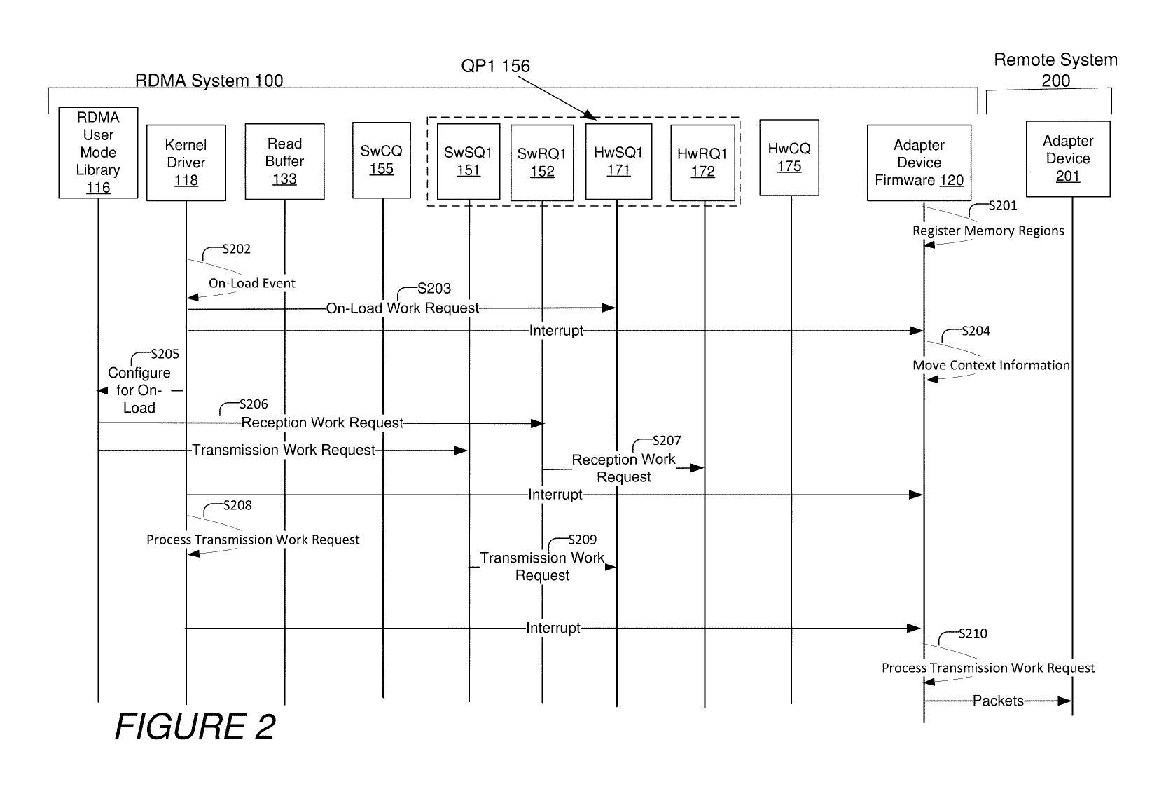

FIG. 2 is a diagram depicting on-loading of the send queue processing and the receive queue processing for the queue pair 156. Although the example implementation shows the involvement of RDMA user mode library 116 and the kernel driver 118 in data path operation, in some implementations the entire operation could be handled completely in the RDMA user mode library 116 or in the kernel driver 118.

At process S201, the send queue processing and the receive queue processing for the queue pair 156 are off-loaded, such that the adapter device 111 performs the send queue processing and the receive queue processing for the queue pair 156. The adapter device 111 performs stateful send queue processing by using the send queue 171. The send queue 171 is accessible by the RDMA user-mode library 116 and the firmware 120. The adapter device 111 performs stateful receive queue processing by using the receive queue 172. The receive queue 172 is accessible by the RDMA user-mode library 116 and the firmware 120. The RDMA user-mode library 116 and the firmware 120 use the adapter device RDMA completion queue (CP) 175 in connection with the send queue 171 and the adapter device receive queue 172.

In the example implementation, the context information for the send queue 171 and the receive queue 172 is included in the context information 182 of the adapter context memory (ACM) address space 181, and the adapter device 111 has ownership of the context information of the send queue 171 and the receive queue 172. In some implementations, the context information for the send queue 171 and the receive queue 172 is included in an adapter device cache in a data storage device that is not included in the adapter device 111 (e.g., a storage device of the RDMA system 100).

The application 113 registers memory regions to be used for RDMA communication, such as a memory region for the write buffer 132 and a memory region for the read buffer 133. The application 113 registers memory regions by using the RDMA Verbs API 115 and the RDMA user mode library 116 to control the adapter device 111 to perform the process defined by the RDMA verb Register Memory Region. The adapter device 111 performs the process defined by the RDMA verb Register Memory Region by creating a protection entry and a translation entry for the memory region being registered.

The application 113 establishes an RDMA connection (e.g., a reliable connection (RC) or an unreliable connection (UC)) with a peer RDMA system via the queue pair 156, followed by data transfer using the RDMA Verbs API 115. The adapter device 111 is responsible for transport, network and link layer functionality.

Because the send queue processing for the queue pair 156 is off-loaded, the RDMA Verbs API 115 and the RDMA User Mode Library 116 enqueue RDMA transmission work requests (WR) received from the application 113 onto the send queue 171 of the adapter device 111, and poll the completion queue 175 of the adapter device for work completions (WC) that indicate completion of processing for the work requests. The adapter device 111 retrieves RDMA transmission work requests from the send queue 171, processes the work requests, generates work completions (WC) that indicate completion of processing for the work requests, and enqueues the generated work completions into the adapter device completion queue 175.

Because the receive queue processing for the queue pair 156 is off-loaded, the RDMA Verbs API 115 and the RDMA User Mode Library 116 enqueue RDMA reception work requests (WR) received from the application 113 onto the receive queue 172, and poll the adapter device completion queue 175 for work completions (WC) that indicate completion of processing for the work requests. The adapter device 111 retrieves RDMA reception work requests from the adapter device receive queue 172, processes the work requests, generates work completions (WC) that indicate completion of processing for the work requests, and enqueues the generated work completions into the adapter device completion queue 175.

At process S202, an on-load event is determined. The on-load event is an event to on-load the send queue processing and the receive queue processing for the queue pair 156. As depicted in FIG. 2, the on-load event at the process S202 is an on-load event for a user consumer (e.g., an example user consumer is RDMA Application 113 of FIG. 1B) executed by the kernel driver 118, and the RDMA kernel driver 118 determines the on-load event. In a case where the RDMA application resides in the kernel space, the RDMA kernel driver 118 executes the on-load event for a kernel consumer (e.g., an example of a kernel consumer is the Kernel RDMA Application 196 of FIG. 1B). More specifically, in the example implementation, the Kernel RDMA Application 196 (the kernel consumer) communicates with the RDMA kernel driver 118 by using the Kernel RDMA Verbs API 197 (of FIG. 1B), and the kernel driver 118 determines the on-load event for the Kernel RDMA Application 196.

In a case where the on-load event is an on-load event for a user consumer (e.g., the application 113 of FIG. 1B), the RDMA user mode library 116 determines the on-load event. More specifically, in the example implementation, the application 113 (the user consumer) communicates with the RDMA user mode library 116 by using the User RDMA Verbs API 115 (of FIG. 1B), and the RDMA user mode library 116 determines the on-load event for the application 113 and provides an on-load notification to the adapter device 111.

Reverting to the on-load event at the process S202 of FIG. 2, in the example implementation, the kernel driver 118 determines the on-load event for the RDMA queue pair 156 based on at least one of operating system events, adapter device events, properties of an application associated with the RDMA transaction, network traffic properties, properties of packets transmitted by the network communication adapter device, and properties of packets received by the network communication adapter device. In the example implementation, the kernel driver 118 determines the on-load event based on, for example, one or more of detection of large packet round trip times (RTT) or acknowledgement (ACK) timeouts, routable properties of packets, and a statistical sampling of network traffic patterns.

In the example implementation, the RDMA verbs API 115 provides a create queue verb that includes a parameter that the application 113 specifies to trigger an on-load event, and the RDMA kernel driver 118 determines an on-load event for the queue pair 156 during creation of the queue pair 156.

At process S203, the kernel driver 118 provides an on-load notification to the adapter device 111 to on-load the send queue processing and the receive queue processing for the queue pair 156. In the example implementation, the on-load notification is a Work Request (WR) whose corresponding Work Queue Element (WQE) has an on-load fence bit in a header of the WQE. A Work Request is the means by which an RDMA consumer requests the creation of a Work Queue Element. A Work Queue Element is the adapter device 111's internal representation of a Work Request. The consumer does not have access to Work Queue Elements. The kernel driver 118 provides the on-load notification to the adapter device 111 (to on-load the send queue processing and the receive queue processing for the queue pair 156) by storing the on-load notification WQE in the adapter device send queue 171 and sending the adapter device 111 an interrupt message to notify the adapter device 111 that the on-load notification WQE is waiting on the adapter device send queue 171. In some implementations, the kernel driver 118 provides the on-load notification to the adapter device 111 to on-load the send queue processing and the receive queue processing for the queue pair 156 by sending the adapter device 111 an interrupt which specifies on-load information. In some implementations, the on-load notification is a Work Queue Element (WQE) that has an on-load fence bit in a header of the WQE.

At process S204, the adapter device 111 accesses the on-load notification WQE stored in the send queue 171. The on-load notification specifies on-loading of the send queue processing and the receive queue processing for the queue pair 156, and includes the on-load fence bit.

In the example implementation, responsive to the on-load fence bit, the adapter device 111 completes processing for all WQE's in the send queue 171 that precede the on-load notification WQE, and determines whether all ACK's for the preceding WQE's have been received by the RDMA system 100. In a case where a local ACK timer timeout or a packet sequence number (PSN) error is detected in connection with processing of a preceding WQE, the adapter device 111 retransmits the corresponding packet until an ACK is received for the retransmitted packet.

In the example implementation, the adapter device 111 completes all in-progress receive queue data transfers (e.g., data transfers in connection with incoming Send, RDMA Read and RDMA Write packets), and responds to new incoming requests with receiver not ready (RNR) negative acknowledgment (NAK) packets. The adapter device 111 updates a context entry for the queue pair 156 in the context information 182 to indicate that the receive queue 172 is in a state in which RNR NAK packets are sent for new incoming requests.

The adapter device 111 discards any pre-fetched WQE's for either the send queue 171 or the receive queue 172, and the adapter device 111 stops pre-fetching WQE's.

In the example implementation, the adapter device 111 flushes the internal context cache entry corresponding to the QP being on-loaded.

In the example implementation, the adapter device 111 synchronizes the context information 182 with any context information stored in a host backed storage that the adapter device 111 uses to store additional context information.

The adapter device 111 moves the context information for the send queue 171 and the receive queue 172 from the context information 182 of the adapter context memory (ACM) address space 181 to the context information 125 of the host context memory (HCM) address space 126. In the example implementation, the HCM address space 126 is registered during creation of the queue pair 156, and the adapter device 111 uses a direct memory access (DMA) operation to move the context information to the HCM address space 126. In the example implementation, the context information of the RDMA queue 156 includes at least one of signaling journals, ACK timers for the RDMA queue 156, and PSN information, incoming read context, outgoing read context and other state information related to protocol processing.

The adapter device 111 changes the ownership of the context information (for the send queue 171 and the receive queue 172) from the adapter device 111 to the RDMA kernel driver 118. In the example implementation, the adapter device 111 changes a queue pair type of the queue pair (QP) 156 to a raw QP type. The raw QP type configures the queue pair 156 for stateless offload assist (SOA). In a stateless offload assist configuration, the adapter device 111 can perform one or more stateless sub-processes of an RDMA transaction for a queue pair for which at least one of send queue processing and receive queue processing is on-loaded. In the example implementation, stateless sub-processes include large segmentation, memory translation and protection, packet header insertion and removal (e.g., L2, L3, and routable headers), invariant cyclic redundancy check (ICRC) computation, and ICRC validation.

At process 5205, the kernel driver 118 detects that the context information for the send queue 171 and the receive queue 172 has been moved to the context information 125 and that the kernel driver 118 has been assigned ownership of the context information (for the send queue 171 and the receive queue 172).

In the example implementation, responsive to the detection that the context information has been moved and ownership has been assigned to the kernel driver 118, the kernel driver 118 configures the RDMA Verbs API 115 and the RDMA user mode library 116 to enqueue RDMA transmission work requests (WR) (received from the application 113) onto the send queue 151, and poll the completion queue 155 for work completions (WC) that indicate completion of processing for the transmission work requests.

In the example implementation, responsive to the detection, the kernel driver 118 configures the RDMA Verbs API 115 and the RDMA User Mode Library 116 to enqueue RDMA-reception work requests (WR) received from the application 113 onto the receive queue 152, and poll the completion queue 155 for work completions (WC) that indicate completion of processing for the reception work requests.

At process S206, the send queue processing and the receive queue processing for the queue pair 156 are on-loaded.

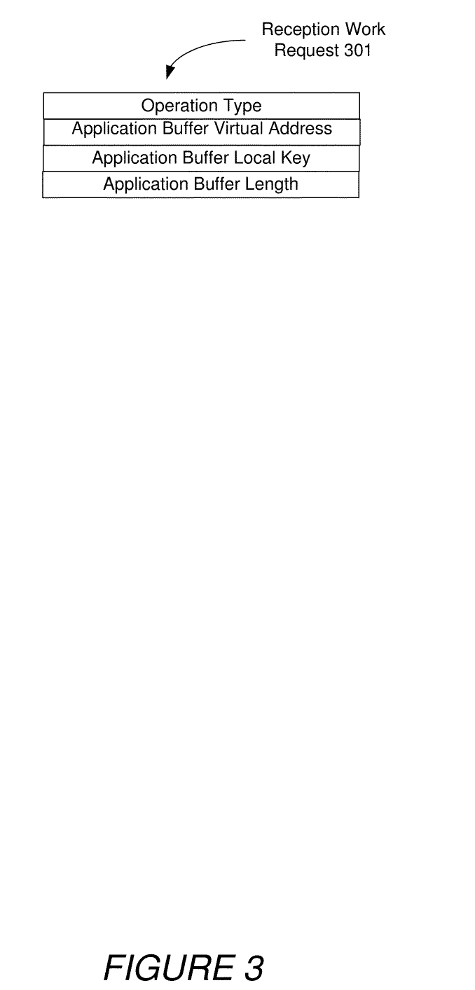

The RDMA verbs API 115 and the RDMA user mode library 116 enqueue a RDMA reception work request (WR) received from the application 113 onto the receive queue 152, and poll the completion queue 155 for a work completion (WC) that indicates completion of processing for the reception work request. The RDMA reception work request specifies at least a receive operation type, and a virtual address, local key and length that identifies a receive buffer (e.g., the receive buffer 134). FIG. 3 is a diagram depicting an exemplary RDMA reception work request 301.

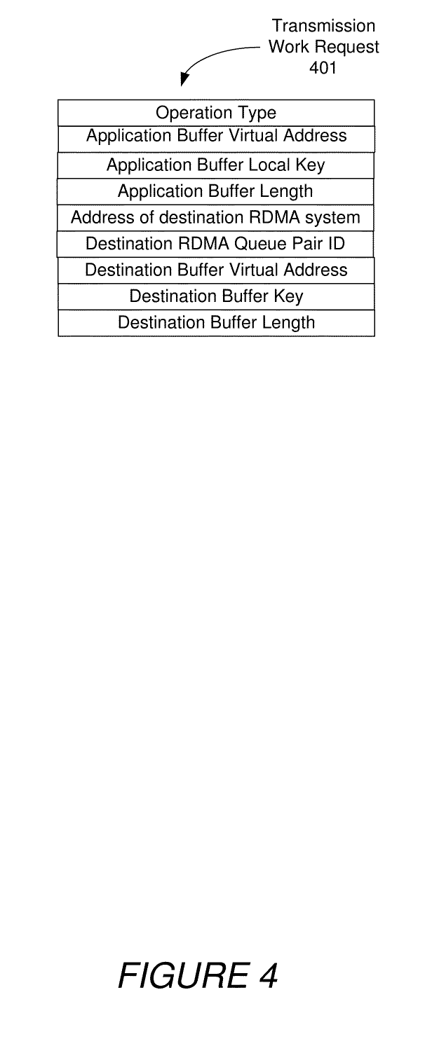

The RDMA Verbs API 115 and the RDMA User Mode Library 116 enqueue an RDMA transmission work request (WR) received from the application 113 onto the send queue 151, and poll the completion queue 155 for a work completion (WC) that indicates completion of processing for the transmission work request. The RDMA transmission work request specifies at least an operation type (e.g., send, RDMA write, RDMA read), a virtual address, local key and length that identifies an application buffer (e.g., one of the send buffer 131, the write buffer 132, and the read buffer 133), an address of a destination RDMA node (e.g., a remote RDMA node or the RDMA system 100), an RDMA queue pair identification (ID) for the destination RDMA queue pair, and a virtual address, remote key and length of a buffer of a memory of the destination RDMA node. FIG. 4 is a diagram depicting an exemplary RDMA transmission work request 401.

The INIFNIBAND Architecture (IBA) specification defines three locally consumed work requests: (i) “fast register physical memory region (MR)”, (ii)“local invalidate,” and (iii) “bind memory windows.” In the example implementation, the RDMA verbs API 115 and the RDMA user mode library 116 do not enqueue locally consumed work requests, except “bind memory windows,” posted by non-privileged consumers (e.g., user space processes). In the example implementation, the kernel RDMA verbs API 197 and the RDMA kernel driver 118 do enqueue locally consumed work requests posted by privileged consumers (e.g., kernel space processes).

At process S207, the kernel driver 118 accesses the RDMA reception work request from the receive queue 152 and identifies the virtual address, local key and length that identifies the receive buffer. The kernel driver 118 generates a context entry for the queue pair 156 that specifies the virtual address, local key and length of the receive buffer, and adds the context entry to the context information 125. The kernel driver 118 stores the RDMA reception work request onto the adapter device receive queue 172 and sends the adapter device 111 an interrupt to notify the adapter device that the RDMA reception work request is waiting on the adapter device receive queue 172.

At process S208, the kernel driver 118 accesses the RDMA transmission work request stored in the send queue 151 and performs at least one sub-process of the RDMA transmission specified by the transmission work request. In the example implementation, sub-processes of the RDMA transmission includes generation of a protocol template header that includes an L2, L3, and L4 header along with the IBA protocol base transport header (BTH) and the RDMA extended transport header (RETH).

In some implementations, a sub-process of the RDMA transmission includes determination of a queue pair identifier, and generation of a protocol template header that includes the determined queue pair identifier and the IBA protocol BTH and RETH headers. The determined queue pair identifier is used by the adapter device 111 as an index into a protocol headers table managed by the adapter device 111. The protocol headers table includes the L2, L3, and L4 headers, and by using the queue pair identifier, the adapter device 111 accesses the L2, L3, and L4 headers for the transmission work request.

At process S209, the kernel driver 118 stores the transmission work request (and the generated protocol template header) on the adapter device send queue 171 and notifies the adapter device 111 that the RDMA transmission work request has been stored on the send queue 171. In the example implementation, the kernel driver 118 sends the adapter device 111 an interrupt to notify the adapter device 111 that the RDMA transmission work request has been stored on the send queue 171.

At process S210, the adapter device 111 accesses the RDMA transmission work request (and the protocol template header) from the adapter device send queue 171 and performs at least one sub-process of the RDMA transmission specified by the transmission work request, in connection with transmission of packets for the work request to the destination node specified in the work request.

In an implementation in which the protocol template header includes the queue pair identifier and does not include one or more of the headers, the adapter device 111 uses the queue pair identifier of the work request as an index into a protocol headers table managed by the adapter device 111. The protocol headers table includes the one or more headers not included in the protocol template header. By using the queue pair identifier, the adapter device 111 accesses the headers for the transmission work request.

In the example implementation, because the queue pair 156 is configured for stateless offload assist, the adapter device 111 performs stateless sub-processes. In some implementations, stateless sub-processes include one or more of Large Segmentation, Memory Translation and Protection for any application buffers (e.g., send buffer 131, write buffer 132, read buffer 133) specified in the transmission work request, insertion of the packet headers (e.g., L2, L3, L4, BTH and RETH headers), and ICRC Computation.

In the example implementation, in a case where the send queue processing for the queue pair 156 is on-loaded, the kernel driver 118 performs retransmission of packets in response to detection of a local ACK timer timeout or a PSN (packet sequence number) error in connection with processing of a transmission WQE. In the example implementation, the kernel driver 118 accesses a received PSN sequence NAK from the adapter device receive queue 172 responsive to an interrupt that notifies the kernel driver 118 that the NAK is waiting on the adapter device receive queue 172. Responsive to the NAK, the kernel driver 118 retrieves the corresponding transmission work request from the software send queue 151, sets a retry flag (e.g., a SQ_RETRY flag), and records the last good PSN. The kernel driver 118 reposts a WQE that for the corresponding transmission work request onto the adapter device send queue 171. Responsive to receipt of an ACK which matches the last good PSN, the kernel driver 118 unsets the retry flag (e.g., the SQ_RETRY flag). The kernel driver 118 maintains the local ACK timer.

In the example implementation, responsive to the first transmission work request posted after the on-load event, the kernel driver 118 starts the corresponding ACK timer and periodically updates the timer based on the ACK frequency and timer management policy.

In the example implementation, in a case where the send queue processing for the queue pair 156 is on-loaded, the kernel driver 118 detects and processes protocol errors. More specifically, in the example implementation, the kernel driver 118 accesses peer generated protocol errors (generated by an RDMA peer device) from the adapter device receive queue 172 responsive to an interrupt that notifies the kernel driver 118 that a packet representing a peer generated protocol error (e.g., a NAK packet for an access violation) is waiting on the adapter device receive queue 172. The kernel driver 118 processes the packet representing the peer generated protocol error. In an example implementation, the kernel driver 118 generates and stores a corresponding error (complete queue error or CQE) into the software completion queue 155. In the example implementation, the kernel driver 118 accesses locally generated protocol errors (e.g., errors for invalid local key access permissions) from the adapter device completion queue 175.

In the example implementation, the kernel driver 118 polls the adapter device completion queue 175 for completion queue errors (CQEs), and processes the CQEs. In processing the CQEs, the kernel driver 118 determines whether a CQE stored on the completion queue 175 corresponds to send queue processing or receive queue processing. In the example implementation, the kernel driver 118 performs management of a moderation parameter for the software completion queue 155 which specifies whether or not signaling is performed for the software completion queue 155.

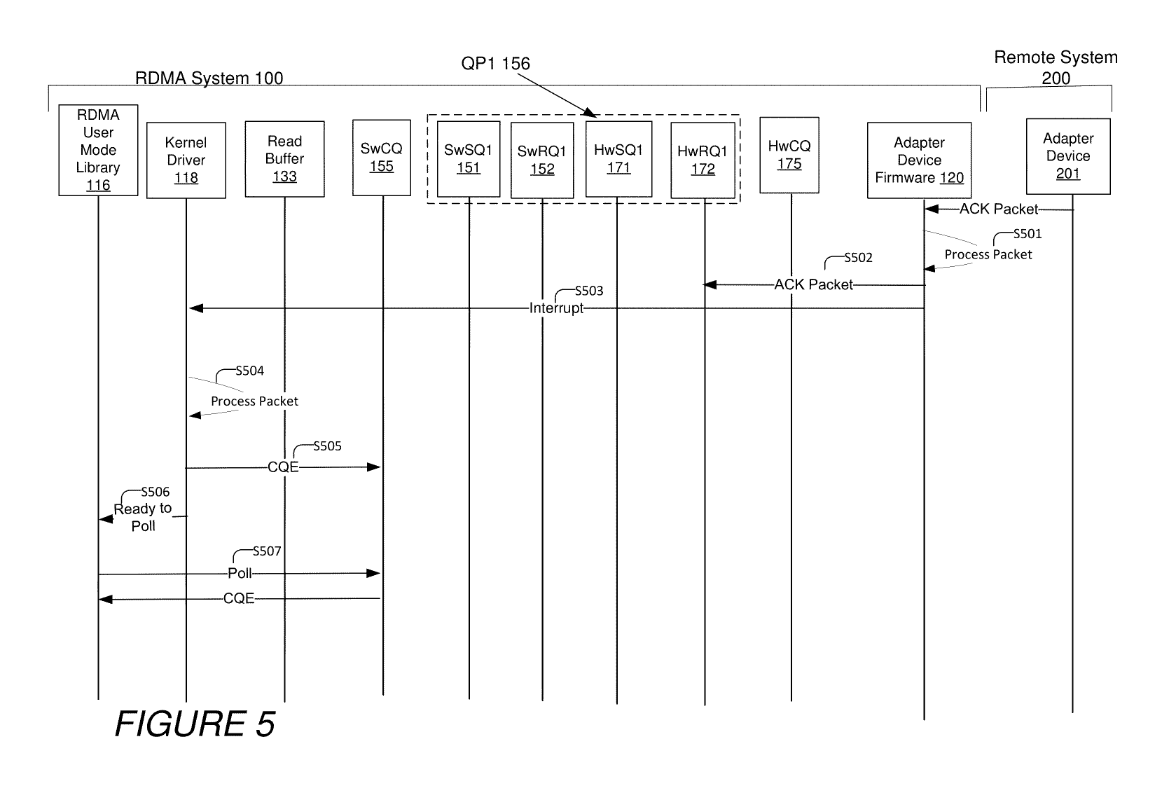

FIG. 5 is a diagram depicting reception of a packet in a case where the send queue processing and the receive queue processing for the queue pair 156 are on-loaded.

At process S501, the adapter device 111 receives a first incoming packet for the queue pair 156 (from a remote system 200) via the network 190, and determines that the incoming packet is a send queue (SQ) packet (e.g., one of an ACK, NAK, read response, atomic response packet) based on at least one of headers and packet structure of the packet. In the example implementation, because the queue pair 156 is configured for stateless offload assist, the adapter device 111 performs stateless sub-processes which include removal of the packet headers (e.g., L2, L3, L4, BTH and RETH headers) from the first packet and ICRC validation.

At process S502, the adapter device 111 adds the first incoming packet to the adapter device receive queue (HWRQ1) 172.

At process S503, the adapter device 111 sends the kernel driver 118 an interrupt to notify the kernel driver 118 that the first incoming packet is waiting on the adapter device receive queue 172. In some implementations, the adapter device 111 adds a CQE to the adapter device completion queue 175 to indicate that the first incoming packet is waiting on the adapter device receive queue 172, and the kernel driver 118 polls the adapter device completion queue 175 to determine whether the first incoming packet is waiting on the adapter device receive queue 172.

At process S504, the kernel driver 118 accesses the first packet from the adapter device receive queue 172, and determines that the incoming packet is a send queue (SQ) packet (e.g., one of an ACK, NAK, read response, atomic response packet) based on at least one of headers and packet structure of the packet. In the example implementation, the kernel driver 118 uses one or more headers of the packet to retrieve a context entry of the context information 125 from the HCM memory address space 126. The kernel driver 118 performs transport validation on the packet by using the retrieved context entry.

At the process S504, the kernel driver 118 determines (based on at least one of headers and packet structure of the packet) that the packet is not a read response packet.

At process S505, the kernel driver 118 determines that the packet is validated and that the retrieved context entry indicates that the packet corresponds to a signaled transmission work request. Accordingly, the kernel driver 118 generates a completion queue entry (CQE) and stores the CQE in the software completion queue 155.

At process S506, after storing the CQE in the completion queue 155, the kernel driver 118 notifies the RDMA user mode library 116 to poll the completion queue 155. In the example implementation, the kernel driver 118 notifies the RDMA user mode library 116 to poll the completion queue 155 by triggering an interrupt.

At process S507, the RDMA user mode library 116 polls the completion queue 155 and receives the CQE.

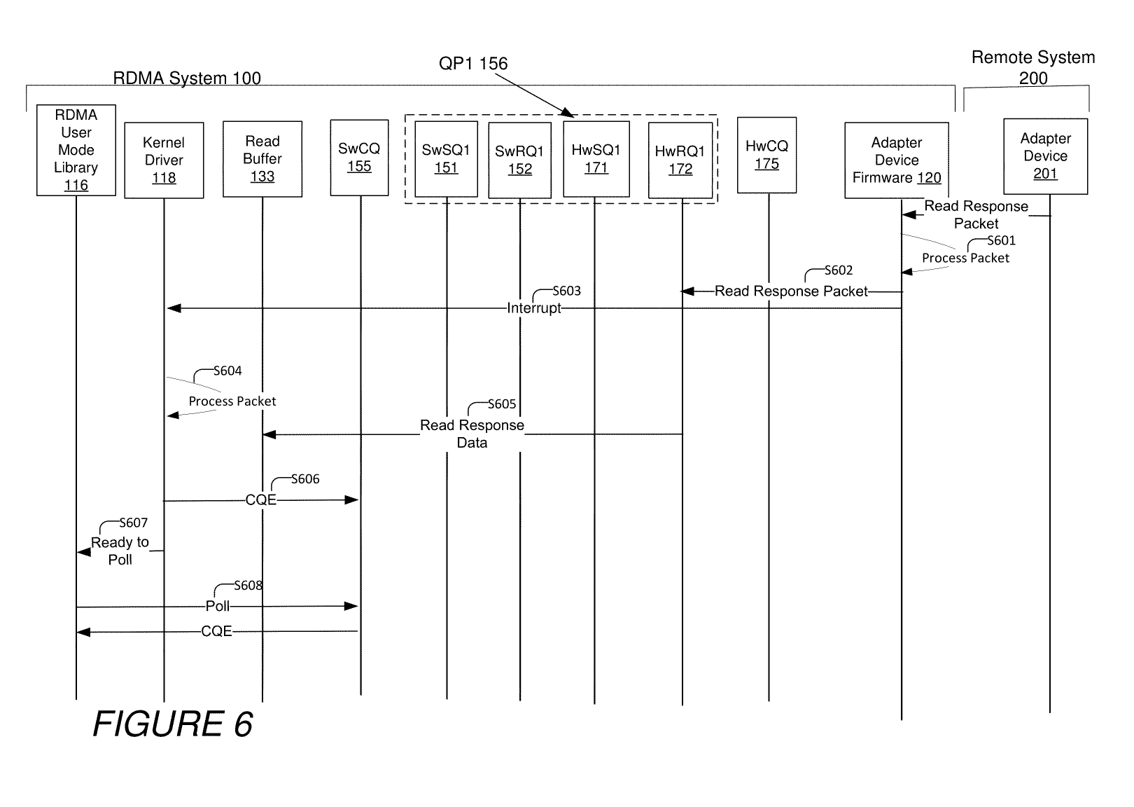

FIG. 6 is a diagram depicting reception of a read response packet in a case where the send queue processing and the receive queue processing for the queue pair 156 are on-loaded.

At process S601, the adapter device 111 receives a second incoming packet for the queue pair 156 via the network 190 (from the adapter device 201 of the remote system 200), and determines that the incoming packet is a read response packet based on at least one of headers and packet structure of the packet. In the example implementation, because the queue pair 156 is configured for stateless offload assist, the adapter device 111 performs stateless sub-processes which include removal of the packet headers (e.g., L2, L3, L4, BTH and RETH headers) from the second packet and ICRC validation.

At process S602, the adapter device 111 adds the second incoming packet to the adapter device receive queue 172.

At process S603, the adapter device 111 sends the kernel driver 118 an interrupt to notify the kernel driver 118 that the second incoming packet is waiting on the adapter device receive queue 172. In some implementations, the adapter device 111 adds a CQE to the adapter device completion queue 175 to indicate that the second incoming packet is waiting on the adapter device receive queue 172, and the kernel driver 118 polls the adapter device completion queue 175 to determine whether the second incoming packet is waiting on the adapter device receive queue 172.

At process S604, the kernel driver 118 accesses the second packet from the adapter device receive queue 172, and determines that the incoming packet is a Read Response packet, based on at least one of headers and packet structure of the packet. In the example implementation, the kernel driver 118 uses one or more headers of the packet to retrieve a context entry of the context information 125 from the HCM memory address space 126. The kernel driver 118 performs transport validation on the packet by using the retrieved context entry.

At processes S605, the kernel driver 118 determines that the packet is validated, and transfers the read response data of the Read Response packet to the read buffer identified in the packet (e.g., the read buffer 133).

At process S606, the kernel driver 118 determines that the retrieved context entry indicates that the packet corresponds to a signaled transmission work request. Accordingly, the kernel driver 118 generates a completion queue entry (CQE) and stores the CQE in the software completion queue 155.

At process S607, after storing the CQE in the completion queue 155, the kernel driver 118 notifies the RDMA user mode library 116 to poll the completion queue 155. In the example implementation, the kernel driver 118 notifies the RDMA user mode library 116 to poll the completion queue 155 by triggering an interrupt.

At process S608, the RDMA user mode library 116 polls the completion queue 155 and receives the CQE.

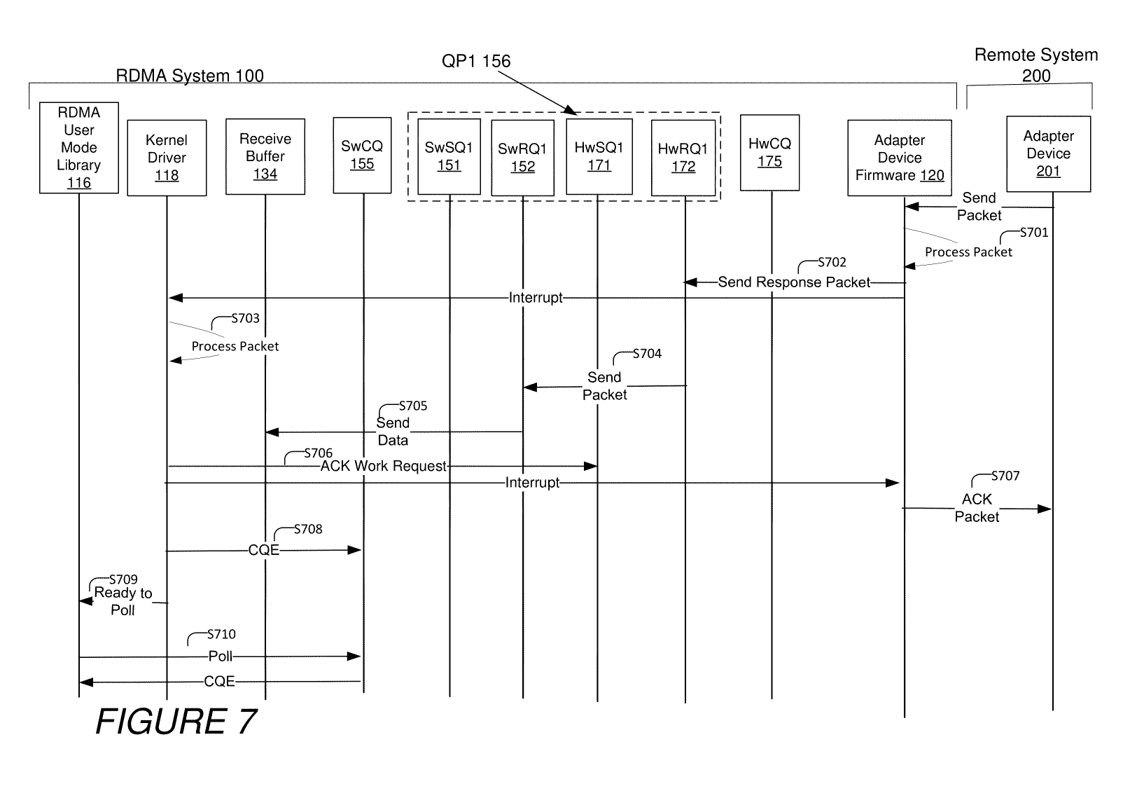

FIG. 7 is a diagram depicting reception of a Send packet in a case where the send queue processing and the receive queue processing for the queue pair 156 are on-loaded.

At process S701, the adapter device 111 receives a third incoming packet for the queue pair 156 via the network 190, and determines that the third incoming packet is a send packet, based on at least one of headers and packet structure of the second packet. The adapter device 111 accesses the RDMA reception work request (stored in the receive queue 172 during the process S207 of FIG. 2) from the adapter device receive queue 172 and performs memory translation and protection checks for the virtual address (or addresses) of the receive buffer (e.g., the receive buffer 134) specified in the RDMA reception work request.

At process S702, the adapter device 111 determines that the protection check performed at the process S701 has passed and the adapter device 111 adds the third incoming packet to the adapter device receive queue 172.

At process S703, the adapter device 111 sends the kernel driver 118 an interrupt to notify the kernel driver 118 that the third incoming packet is waiting on the adapter device receive queue 172. In some implementations, the adapter device 111 adds a CQE to the adapter device completion queue 175 to indicate that the third incoming packet is waiting on the adapter device receive queue 172, and the kernel driver 118 polls the adapter device completion queue 175 to determine whether the third incoming packet is waiting on the adapter device receive queue 172.

In the example implementation, responsive to the interrupt, the kernel driver 118 accesses the third packet from the adapter device receive queue 172, and determines that the third incoming packet is a Send packet, based on at least one of headers and packet structure of the packet. In the example implementation, the kernel driver 118 uses one or more headers of the third incoming packet to retrieve a context entry of the context information 125 from the HCM memory address space 126. The kernel driver 118 performs transport validation on the third incoming packet by using the retrieved context entry.

At process S704, the kernel driver 118 determines that the transport validation performed at the process S703 has passed and the kernel driver 118 stores the third incoming packet in the software receive queue 152 of the queue pair 156.

At process S705, the kernel driver 118 accesses the RDMA reception work request posted to the software receive queue 152 during the process S206 (of FIG. 2), identifies the receive buffer (e.g., the receive buffer 134) specified by the RDMA reception work request, pages in the physical pages corresponding to the receive buffer, and stores data of the second packet in the receive buffer.

At process S706, the kernel driver 118 generates an ACK work request and posts the ACK work request to the adapter device send queue 171. The kernel driver 118 sends the adapter device 111 an interrupt to notify the adapter device 111 that the ACK work request is waiting on the adapter device send queue 171.

At process S707, the adapter device 111 accesses the ACK work request from the send queue 171 and processes the ACK work request by sending an ACK packet to the sender of the third packet (e.g., the adapter device 201 of the remote system 200).

At process S708, the kernel driver 118 generates a completion queue entry (CQE) and stores the CQE in the software completion queue 155.

At process S709, after storing the CQE in the completion queue 155, the kernel driver 118 notifies the RDMA user mode library 116 to poll the completion queue 155. In the example implementation, the kernel driver 118 notifies the RDMA user mode library 116 to poll the completion queue 155 by triggering an interrupt.

At process S710, the RDMA user mode library 116 polls the completion queue 155 and receives the CQE.

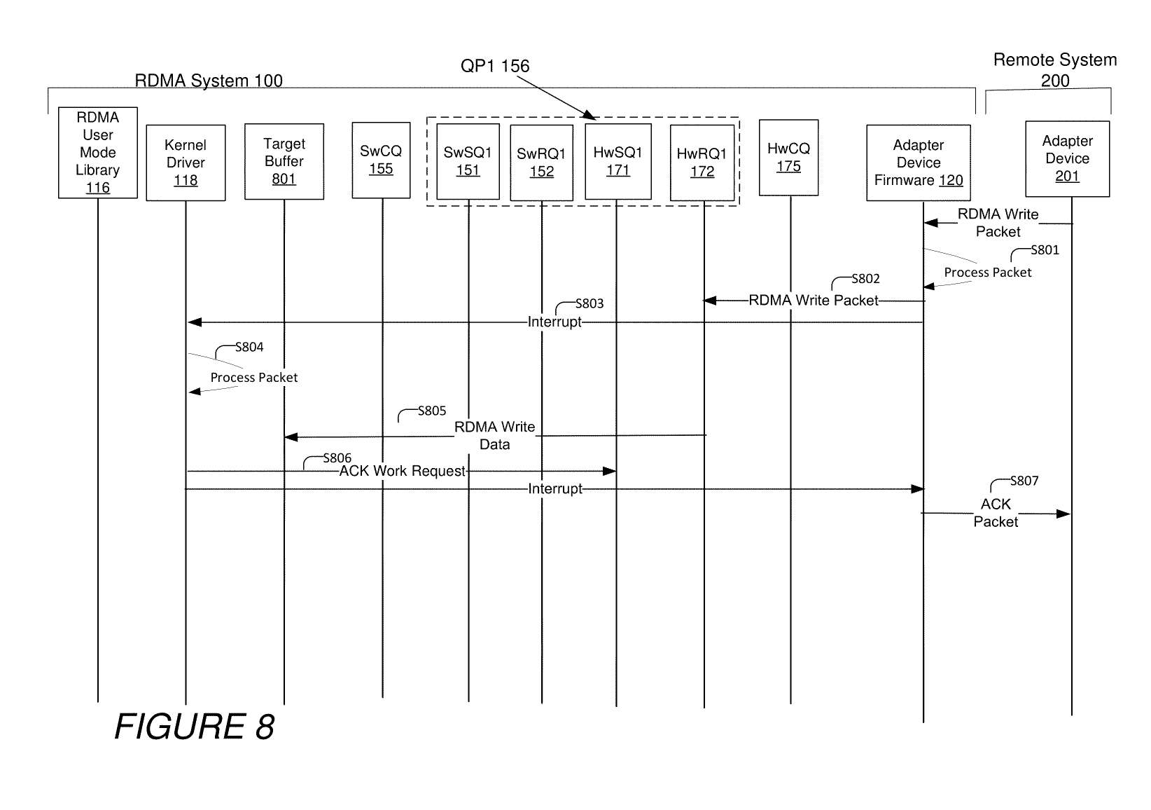

FIG. 8 is a diagram depicting reception of a RDMA Write packet in a case where the send queue processing and the receive queue processing for the queue pair 156 are on-loaded.

At process S801, the adapter device 111 receives a fourth incoming packet for the queue pair 156 via the network 190, and determines that the fourth incoming packet is an RDMA Write packet, based on at least one of headers and packet structure of the third packet. The adapter device 111 identifies a virtual address, remote key and length of a target buffer 801 (specified in the packet) that corresponds to the application address space 130 of the main memory 122, and the adapter device 111 performs memory translation and protection checks for the virtual address of the target buffer 801.

At process S802, the adapter device 111 determines that the protection check performed at the process S801 has passed, and the adapter device 111 adds the fourth incoming packet to the adapter device receive queue 172.

At process S803, the adapter device 111 sends the kernel driver 118 an interrupt to notify the kernel driver 118 that the fourth incoming packet is waiting on the adapter device receive queue 172. In some implementations, the adapter device 111 adds a CQE to the adapter device completion queue 175 to indicate that the fourth incoming packet is waiting on the adapter device receive queue 172, and the kernel driver 118 polls the adapter device completion queue 175 to determine whether the fourth incoming packet is waiting on the adapter device receive queue 172.

In the example implementation, responsive to the interrupt, at process S804, the kernel driver 118 accesses the fourth packet from the adapter device receive queue 172, and determines that the fourth incoming packet is a RDMA Write packet, based on at least one of headers and packet structure of the fourth incoming packet. In the example implementation, the kernel driver 118 uses one or more headers of the fourth incoming packet to retrieve a context entry of the context information 125 from the HCM memory address space 126. The kernel driver 118 performs transport validation on the fourth incoming packet by using the retrieved context entry.

At process S805, the kernel driver 118 determines that the transport validation performed at the process S804 has passed and the kernel driver 118 identifies the target buffer 801 specified in the fourth packet, and stores data of the fourth packet in the target buffer 801. In the example implementation, the kernel driver 118 does not generate a completion queue entry (CQE) for RDMA write packets.

At process S806, the kernel driver 118 generates an ACK work request and posts the ACK work request to the adapter device send queue 171. The kernel driver 118 sends the adapter device 111 an interrupt to notify the adapter device that the ACK work request is waiting on the adapter device send queue 171.

At process S807, the adapter device 111 accesses the ACK work request from the send queue 171 and processes the ACK work request by sending an ACK packet to the sender of the fourth packet (e.g., the adapter device 201 of the remote system 200).

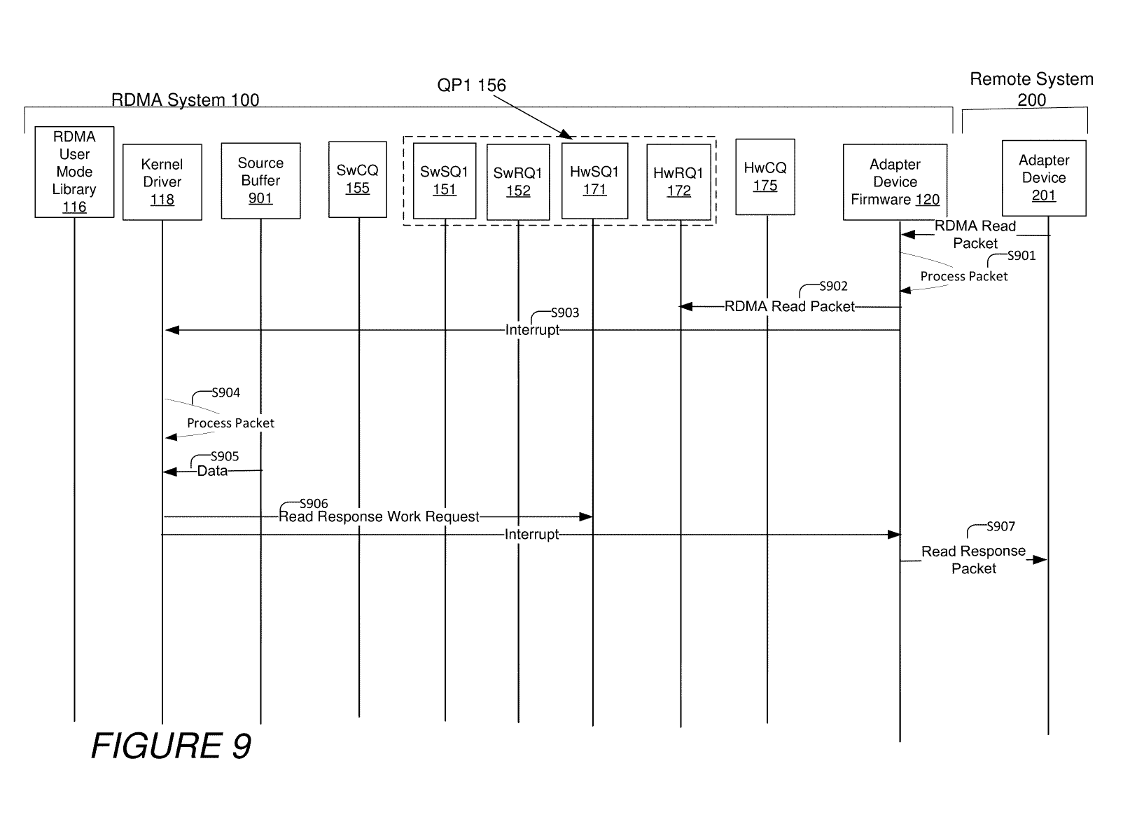

FIG. 9 is a diagram depicting reception of a RDMA read packet in a case where the send queue processing and the receive queue processing for the queue pair 156 are on-loaded.

At process S901, the adapter device 111 receives a fifth incoming packet for the queue pair 156 via the network 190, and the adapter device 111 determines that the fifth incoming packet is an RDMA read packet, based on at least one of headers and packet structure of the fifth packet. The adapter device 111 identifies a virtual address, remote key and length of a source buffer (specified in the packet) that corresponds to the application address space 130 of the main memory 122, and the adapter device 111 performs memory translation and protection checks for the virtual address of the source buffer.

At process S902, the adapter device 111 determines that the protection check performed at the process S901 has passed, and adds the fifth incoming packet to the adapter device receive queue 172.

At process S903, the adapter device 111 sends the kernel driver 118 an interrupt to notify the kernel driver 118 that the fifth incoming packet is waiting on the adapter device receive queue 172. In some implementations, the adapter device 111 adds a CQE to the adapter device completion queue 175 to indicate that the fifth incoming packet is waiting on the adapter device receive queue 172, and the kernel driver 118 polls the adapter device completion queue 175 to determine whether the fifth incoming packet is waiting on the adapter device receive queue 172.

At process S904, the kernel driver 118 accesses the fifth packet from the adapter device receive queue 172, and determines that the incoming packet is a RDMA Read packet, based on at least one of headers and packet structure of the packet. In the example implementation, the kernel driver 118 uses one or more headers of the packet to retrieve a context entry of the context information 125 from the HCM memory address space 126. The kernel driver 118 performs transport validation on the packet by using the retrieved context entry.

At process S905, the kernel driver 118 identifies the source buffer 901 specified in the fifth packet, and reads data stored in the source buffer 901.

At process S906, the kernel driver 118 generates a read response work request that includes the data read from the source buffer 901. The kernel driver 118 posts the read response work request to the adapter device send queue 171. The kernel driver 118 sends the adapter device 111 an interrupt to notify the adapter device 111 that the read response work request is waiting on the adapter device send queue 171.

At process S907, the adapter device 111 accesses the read response work request from the send queue 171 and processes the read response work request by sending at least one read response packet to the adapter device 201 of the remote system 200.

In the example implementation, the kernel driver does not generate a completion queue entry (CQE) for RDMA read packets.

In the example implementation, the adapter device send queue (e.g., queues 171 and 173) is used for send queue processing and receive queue processing, and the adapter device receive queue (e.g., queues 172 and 174) is used for send queue processing and receive queue processing. Since the send queue processing and the receive queue processing share RDMA queues, the kernel driver 118 performs scheduling to improve system performance. In the example implementation, for an adapter device send queue (e.g., queues 171 and 173) the kernel driver 118 prioritizes outbound read responses and outbound atomic responses over outbound send work requests and outbound RDMA write work requests. In the example implementation, for an adapter device receive queue (e.g., queues 172 and 174) the kernel driver 118 performs acknowledgment coalescing for incoming send, RDMA read, atomic and RDMA write packets.

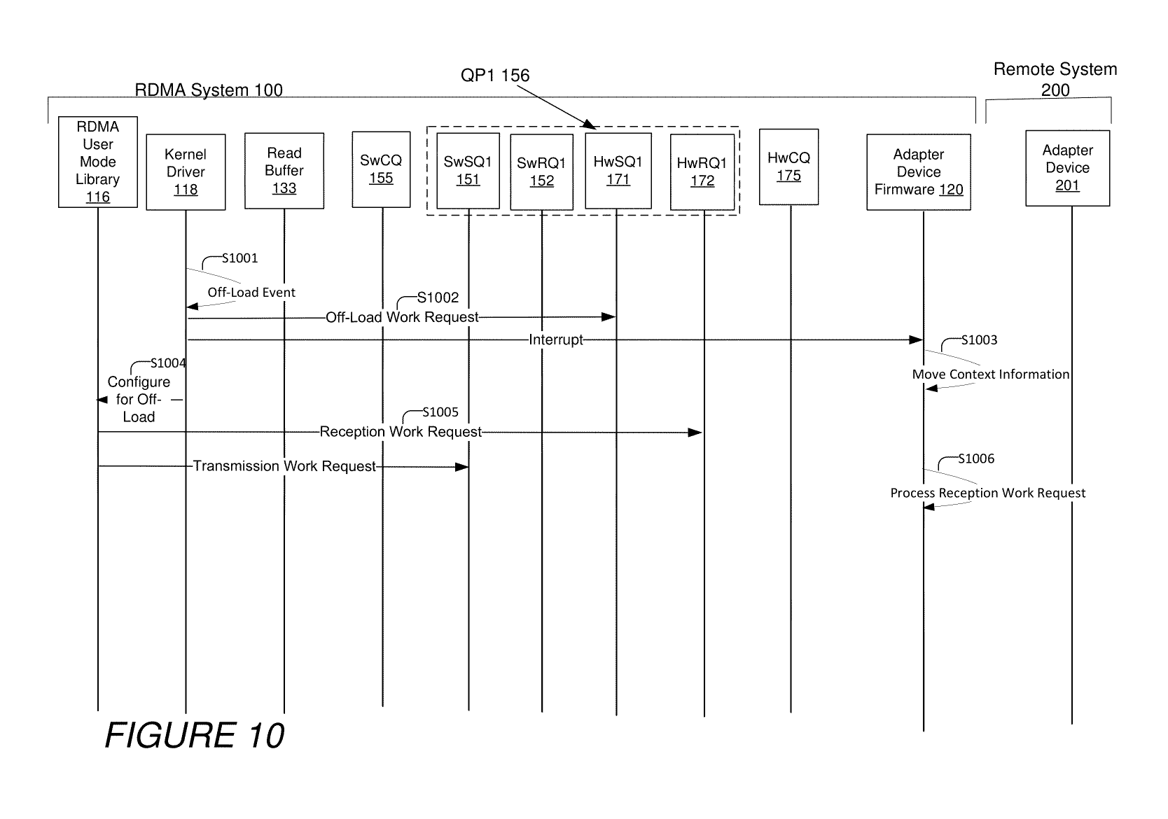

FIG. 10 is a diagram depicting off-loading of the receive queue processing for the queue pair 156 (while the send queue processing for the queue pair 156 remains on-loaded).

At process S1001, an off-load event is determined. The off-load event is an event to offload the receive queue processing for the queue pair 156. As depicted in FIG. 10, the off-load event at the process S1001 is an off-load event for a user consumer (e.g., RDMA Application 113 of FIG. 1B) executed by the kernel driver 118, and the RDMA kernel driver 118 determines the off-load event. In a case where the RDMA application resides in the kernel space, the RDMA kernel driver 118 executes the off-load event for a kernel consumer (e.g., the Kernel RDMA Application 196 of FIG. 1B). More specifically, in the example implementation, the Kernel RDMA Application 196 (the kernel consumer) communicates with the RDMA kernel driver 118 by using the Kernel RDMA Verbs API 197 (of FIG. 1B), and the kernel driver 118 determines the off-load event for the Kernel RDMA Application 196.

In a case where the off-load event is an off-load event for a user consumer (e.g., the application 113 of FIG. 1B), the RDMA user mode library 116 determines the off-load event. More specifically, in the example implementation, the application 113 (the user consumer) communicates with the RDMA user mode library 116 by using the User RDMA Verbs API 115 (of FIG. 1B), and the RDMA user mode library 116 determines the off-load event for the application 113 and provides an off-load notification to the adapter device 111.

Reverting to the off-load event at the process S1001 of FIG. 10, in the example implementation, the kernel driver 118 determines the off-load event for the RDMA queue pair 156 based on at least one of operating system events, adapter device events, properties of an application associated with the RDMA transaction, network traffic properties, properties of packets transmitted by the network communication adapter device, and properties of packets received by the network communication adapter device. In the example implementation, the kernel driver 118 determines the off-load event based on, for example, one or more of detection of large packet round trip times (RTT) or ACK timeouts, routable properties of packets, and a statistical sampling of network traffic patterns.

In the example implementation, responsive to the determination of the off-load event, the kernel driver 118 flushes the Lx caches of the context entry corresponding to the QP being off-loaded.

In the example implementation, the RDMA verbs API 115 provides a create queue verb that includes a parameter that the application 113 specifies to trigger an off-load event, and the RDMA kernel driver 118 determines an off-load event for the queue pair 156 during creation of the queue pair 156.

At process S1002, the kernel driver 118 provides an off-load notification to the adapter device 111 to off-load the receive queue processing for the queue pair 156. In the example implementation, the off-load notification is a Work Request (WR) whose corresponding Work Queue Element (WQE) has an off-load fence bit in a header of the WQE. The kernel driver 118 provides the off-load notification to the adapter device 111 (to off-load the receive queue processing for the queue pair 156) by storing the off-load notification WQE in the adapter device send queue 171 and sending the adapter device 111 an interrupt to notify the adapter device 111 that the off-load notification WQE is waiting on the adapter device send queue 171. In some implementations, the kernel driver 118 provides the off-load notification to the adapter device 111 to off-load the receive queue processing for the queue pair 156 by sending the adapter device 111 an interrupt which specifies off-load information. In some implementations, the off-load notification is a Work Queue Element (WQE) that has an off-load fence bit in a header of the WQE.

At process S1003, the adapter device 111 accesses the off-load notification WQE stored in the send queue 171. The off-load notification specifies off-loading of the receive queue processing for the queue pair 156, and includes the off-load fence bit.

In the example implementation, responsive to the off-load fence bit, the adapter device 111 moves the context information for the receive queue 172 from context information 125 of the host context memory (HCM) address space 126 to the context information 182 of the adapter context memory (ACM) address space 181. In the example implementation, the HCM address space 126 is registered during creation of the queue pair 156, and the adapter device 111 uses a direct memory access (DMA) operation to move the context information from the HCM address space 126.

The adapter device 111 changes the ownership of the context information (for the receive queue 172) from the RDMA kernel driver 118 to the adapter device 111. In the example implementation, because the send queue processing for the queue pair 156 remains on-loaded, the adapter device 111 does not change the queue pair type of the queue pair (QP) 156 from the raw QP type to an RC or a UC connection type. In other words, the queue pair type of the QP 156 remains a raw QP type.

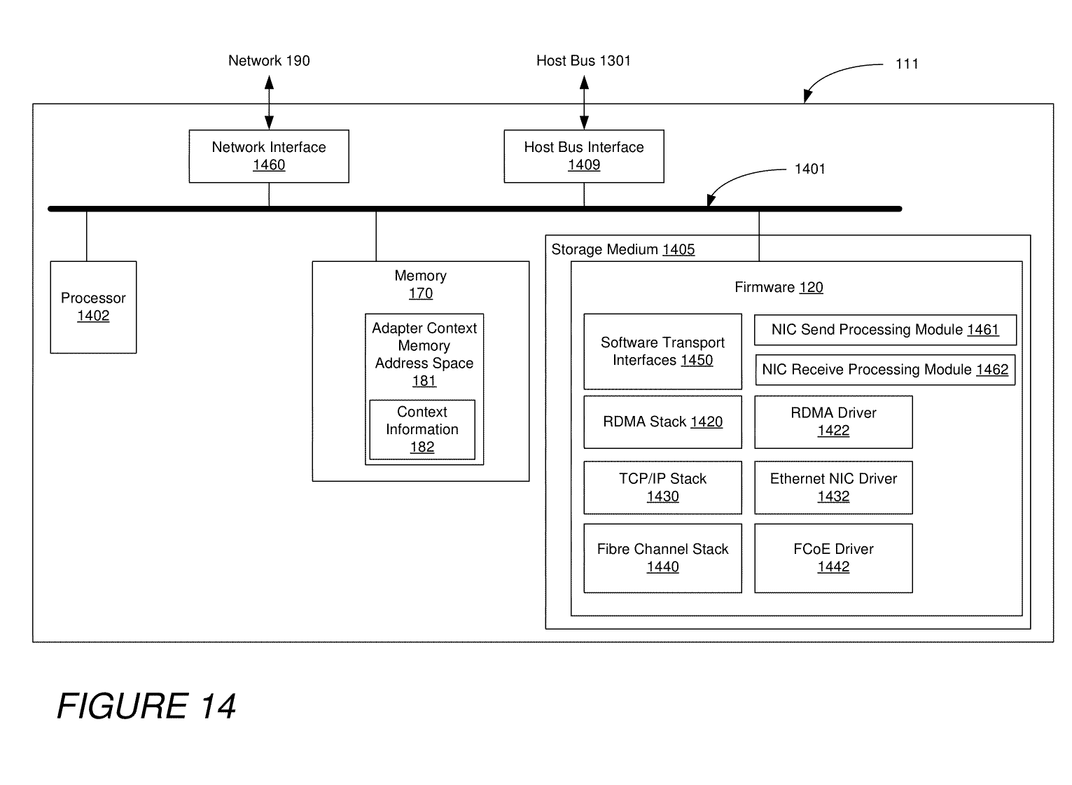

In the example implementation, because the QP 156 remains a raw QP type, a receive queue processing module of the QP 156 (included in the adapter device firmware 120) does not perform stateful receive queue processing, such as, for example, transport validation, and the like. Instead, a stateful receive queue processing module (e.g., a network interface controller (NIC/RDMA) receive queue processing module 1462 of FIG. 14) that is separate from the receive queue processing module of the QP 156 performs the stateful receive queue processing. More specifically, in the example implementation, a network interface controller (NIC/RDMA) receive queue processing module of the adapter device firmware 120 uses the context entry (included in the context information 182) to perform stateful processing for received responder side packets, e.g., incoming SEND, WRITE, READ and Atomics packets. The requester side packets (e.g. ACK, NAK, read responses and atomic responses) are not subjected to stateful processing in the adapter device 111. The requester side processing remains onloaded.

At process S1004, the adapter device 111 detects that the context information for the receive queue 172 has been moved to the context information 182 and that the adapter device 111 has been assigned ownership of the context information (for the receive queue 172).

In the example implementation, responsive to the detection that the context information has been moved and ownership has been assigned to the adapter device 111, the adapter device 111 configures the RDMA verbs API 115 and the RDMA user mode library 116 to enqueue RDMA reception work requests (WR) received from the application 113 onto the receive queue 172, and poll the completion queue 175 for work completions (WC) that indicate completion of processing for the reception work requests.

At process S1005, the receive queue processing for the queue pair 156 is off-loaded, while the send queue processing for the queue pair 156 remains on-loaded.

The RDMA Verbs API 115 and the RDMA User Mode Library 116 enqueue a RDMA reception work request (WR) received from the application 113 onto the receive queue 172, and poll the completion queue 175 for a work completion (WC) that indicates completion of processing for the reception work request. The RDMA reception work request specifies at least a Receive operation type, and a virtual address, local key and length that identifies a receive buffer (e.g., the receive buffer 134).

At process S1006, the adapter device 111 accesses the RDMA reception work request from the receive queue 172 and identifies the virtual address, local key and length that identifies the receive buffer. The adapter device 111 generates a context entry for the queue pair 156 that specifies the virtual address, local key and length of the receive buffer, and adds the context entry to the context information 182. As described above for the process S1003, the NIC/RDMA receive queue processing module of the adapter device firmware 120 uses the context entry (included in the context information 182) to perform stateful processing for responder side packets, e.g. incoming SEND, WRITE, READ and Atomics packets.

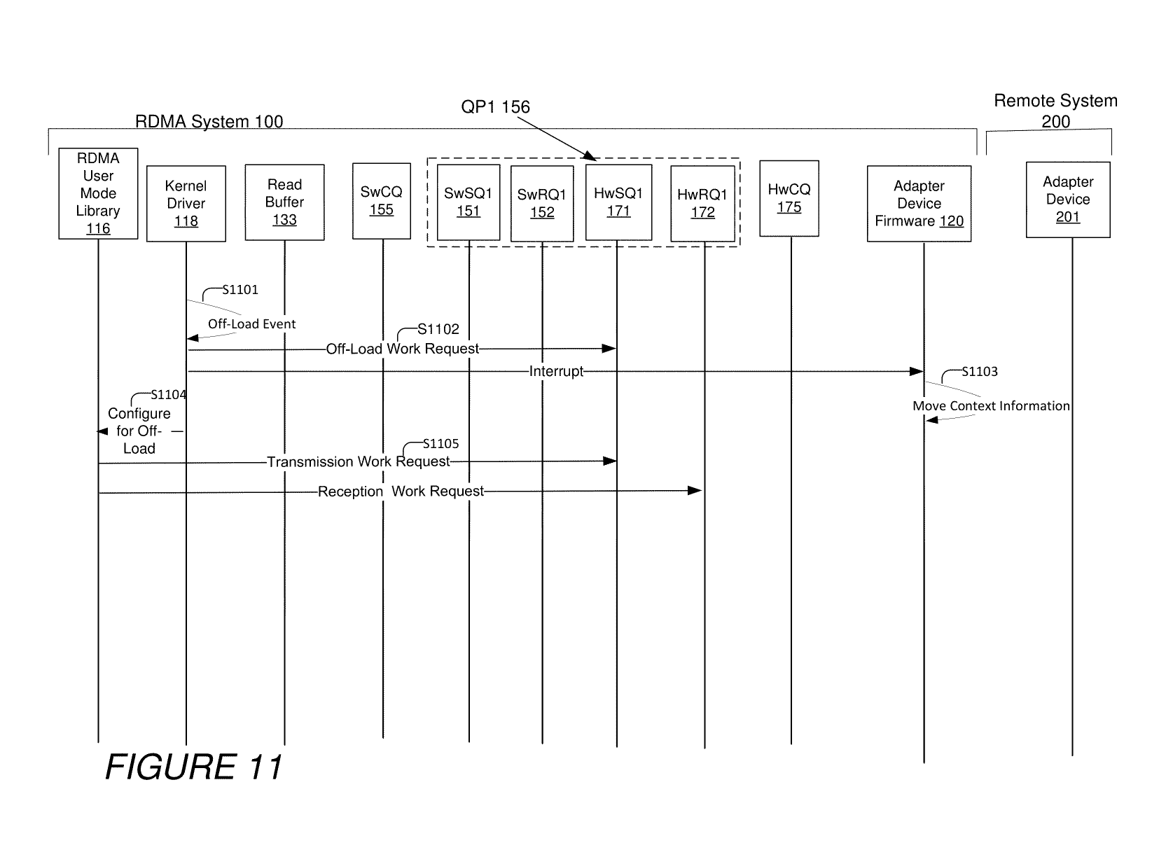

FIG. 11 is a diagram depicting off-loading of the send queue processing for the queue pair 156 (while the receive queue processing for the queue pair 156 remains off-loaded).

At process S1101, an off-load event is determined. The off-load event is an event to off-load the send queue processing for the queue pair 156. As depicted in FIG. 11, the off-load event at the process S1101 is an off-load event for a user consumer (e.g., RDMA Application 113 of FIG. 1B) executed by the kernel driver 118, and the RDMA kernel driver 118 determines the off-load event. In a case where the RDMA application resides in the kernel space, the RDMA kernel driver 118 executes the off-load event for a kernel consumer (e.g., the Kernel RDMA Application 196 of FIG. 1B). More specifically, in the example implementation, the Kernel RDMA Application 196 (the kernel consumer) communicates with the RDMA kernel driver 118 by using the Kernel RDMA Verbs API 197 (of FIG. 1B), and the kernel driver 118 determines the off-load event for the Kernel RDMA Application 196.

In a case where the off-load event is an off-load event for a user consumer (e.g., the application 113 of FIG. 1B), the RDMA user mode library 116 determines the off-load event. More specifically, in the example implementation, the application 113 (the user consumer) communicates with the RDMA user mode library 116 by using the User RDMA Verbs API 115 (of FIG. 1B), and the RDMA user mode library 116 determines the off-load event for the application 113 and provides an off-load notification to the adapter device 111.

Reverting to the off-load event at the process S1101 of FIG. 11, in the example implementation, responsive to the determination of the off-load event, the kernel driver 118 flushes the Lx caches of the context entry corresponding to the QP being off-loaded.

In the example implementation, the RDMA verbs API 115 provides a Create Queue verb that includes a parameter that the application 113 specifies to trigger an off-load event, and the RDMA kernel driver 118 determines an off-load event for the queue pair 156 during creation of the queue pair 156. In some implementations, based on application usage patterns, network and traffic information, and the like, send queue offloading could be done at a later stage rather than at the queue pair creation stage,

At process S1102, the kernel driver 118 provides an off-load notification to the adapter device 111 to off-load the send queue processing for the queue pair 156. In the example implementation, the off-load notification is a Work Request (WR) whose corresponding Work Queue Element (WQE) has an off-load fence bit in a header of the WQE. The kernel driver 118 provides the off-load notification to the adapter device 111 (to off-load the send queue processing for the queue pair 156) by storing the off-load notification WQE in the adapter device send queue 171 and sending the adapter device 111 an interrupt to notify the adapter device 111 that the off-load notification WQE is waiting on the adapter device send queue 171. In some implementations, the kernel driver 118 provides the off-load notification to the adapter device 111 to off-load the receive queue processing for the queue pair 156 by sending the adapter device 111 an interrupt which specifies off-load information. In some implementations, the off-load notification is a Work Queue Element (WQE) that has an off-load fence bit in a header of the WQE.

At process S1103, the adapter device 111 accesses the off-load notification WQE stored in the send queue 171. The off-load notification specifies off-loading of the send queue processing for the queue pair 156, and includes the off-load fence bit.

In the example implementation, responsive to the off-load fence bit, the adapter device 111 moves the context information for the send queue 171 from context information 125 of the host context memory (HCM) address space 126 to the context information 182 of the adapter context memory (ACM) address space 181.

The adapter device 111 changes the ownership of the context information (for the send queue 171) from the RDMA kernel driver 118 to the adapter device 111. In the example implementation, because both the send queue processing and the receive queue processing for the queue pair 156 are off-loaded, the adapter device 111 changes the queue pair type of the queue pair (QP) 156 from the raw QP type to an RC or a UC connection type.

In the example implementation, because the QP 156 is no longer a raw QP type, a NIC/RDMA send queue processing module and the NIC/RDMA receive queue processing module of the QP 156 (included in the adapter device firmware 120) perform stateful send queue processing and stateful receive queue processing, such as, for example, transport validation, and the like. More specifically, in the example implementation, the NIC/RDMA send queue processing module and the NIC/RDMA receive queue processing module of the QP 156 of the adapter device firmware 120 perform any stateful send queue or receive queue processing by using the context information 182.

In general, a send queue processing module and a receive queue processing module in the main memory 122 are used for on-loaded send queues and receive queues, respectively. These processing modules manage the raw send queue and the raw receive queue in the on-loaded mode. The NIC/RDMA send queue processing module and the NIC/RDMA receive queue processing module are used for offloaded send queues and offloaded receive queues, respectively. However, in some implementations, these contexts could be merged when operating in an off-loaded state

At process S1104, the adapter device 111 detects that the context information for the send queue 171 has been moved to the context information 182 and that the adapter device 111 has been assigned ownership of the context information (for the send queue 171).

In the example implementation, responsive to the detection that the context information has been moved and ownership has been assigned to the adapter device 111, the adapter device 111 configures the RDMA verbs API 115 and the RDMA User Mode Library 116 to enqueue RDMA transmission work requests (WR) received from the application 113 onto the send queue 171, and poll the completion queue 175 for work completions (WC) that indicate completion of processing for the transmission work requests.

At process S1105, the send queue processing and the receive queue processing for the queue pair 156 are both off-loaded.

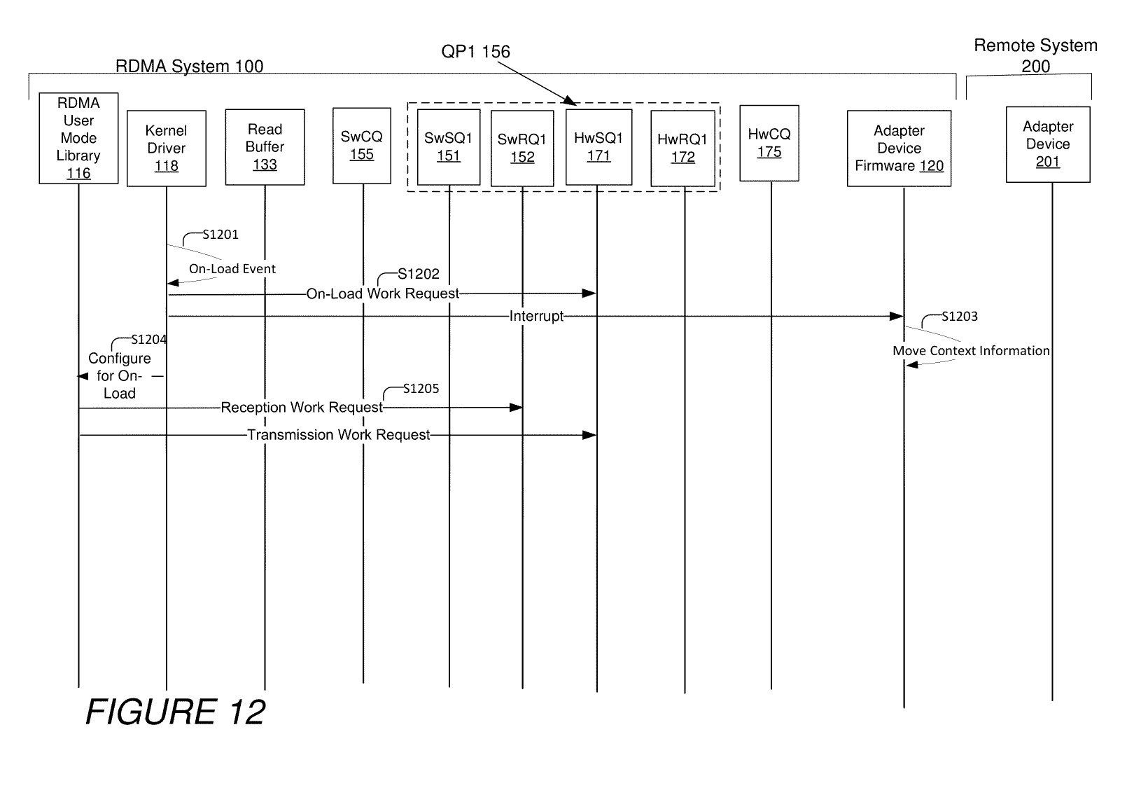

FIG. 12 is a diagram depicting on-loading of the receive queue processing for the queue pair 156 (while the send queue processing for the queue pair 156 remains off-loaded).

At process S1201, the RDMA kernel driver 118 determines an on-load event to onload the receive queue processing for the queue pair 156.

At process S1201, an on-load event is determined. The on-load event is an event to on-load the receive queue processing for the queue pair 156. As depicted in FIG. 12, the on-load event at the process S1201 is an on-load event for a user consumer (e.g., RDMA Application 113 of FIG. 1B) executed by the kernel driver 118, and the RDMA kernel driver 118 determines the on-load event. In a case where the RDMA application resides in the kernel space, the RDMA kernel driver 118 executes the on-load event for a kernel consumer (e.g., the Kernel RDMA Application 196 of FIG. 1B). More specifically, in the example implementation, the Kernel RDMA Application 196 (the kernel consumer) communicates with the RDMA kernel driver 118 by using the Kernel RDMA Verbs API 197 (of FIG. 1B), and the kernel driver 118 determines the on-load event for the Kernel RDMA Application 196.

In a case where the on-load event is an on-load event for a user consumer (e.g., the application 113 of FIG. 1B), the RDMA user mode library 116 determines the on-load event. More specifically, in the example implementation, the application 113 (the user consumer) communicates with the RDMA user mode library 116 by using the User RDMA Verbs API 115 (of FIG. 1B), and the RDMA user mode library 116 determines the on-load event for the application 113 and provides an on-load notification to the adapter device 111.

At process S1202, the kernel driver 118 provides an on-load notification to the adapter device 111 to on-load the receive queue processing for the queue pair 156, as described above for FIG. 2.

At process S1203, the adapter device 111 performs on-loading for the receive queue processing as described above for process S204 of FIG. 2.

The adapter device 111 moves the context information for the receive queue 172 from the context information 182 of the adapter context memory (ACM) address space 181 to the context information 125 of the host context memory (HCM) address space 126.

The adapter device 111 changes the ownership of the context information (for the receive queue 172) from the adapter device 111 to the RDMA kernel driver 118. In the example implementation, the adapter device 111 changes a queue pair type of the queue pair (QP) 156 to the raw QP type.

In the example implementation, because the QP 156 is changed to the Raw QP type, a send queue processing module of the QP 156 (included in the adapter device firmware 120) does not perform stateful send queue processing, such as, for example, transport validation, and the like. Instead, a stateful send queue processing module (e.g., a network interface controller (NIC) send queue processing module 1461 of FIG. 14) that is separate from the send queue processing module of the QP 156 performs the stateful send queue processing. More specifically, in the example implementation, a network interface controller (NIC) send queue processing module of the adapter device firmware 120 manages signaling journals and ACK timers, and performs any stateful send queue processing for the transmitted packets by using the context information 182.

At process S1204, the kernel driver 118 detects that the context information for the receive queue 172 has been moved to the context information 125 and that the kernel driver 118 has been assigned ownership of the context information (for the receive queue 172).

In the example implementation, responsive to the detection that the context information has been moved and ownership has been assigned to the kernel driver 118, the kernel driver 118 configures the RDMA verbs API 115 and the RDMA user mode library 116 to enqueue RDMA reception work requests (WR) (received from the application 113) onto the receive queue 152, and poll the completion queue 155 for work completions (WC) that indicate completion of processing for the reception work requests.

At process S1205, the receive queue processing for the queue pair 156 is on-loaded, and the send queue processing for the queue pair 156 remains off-loaded.

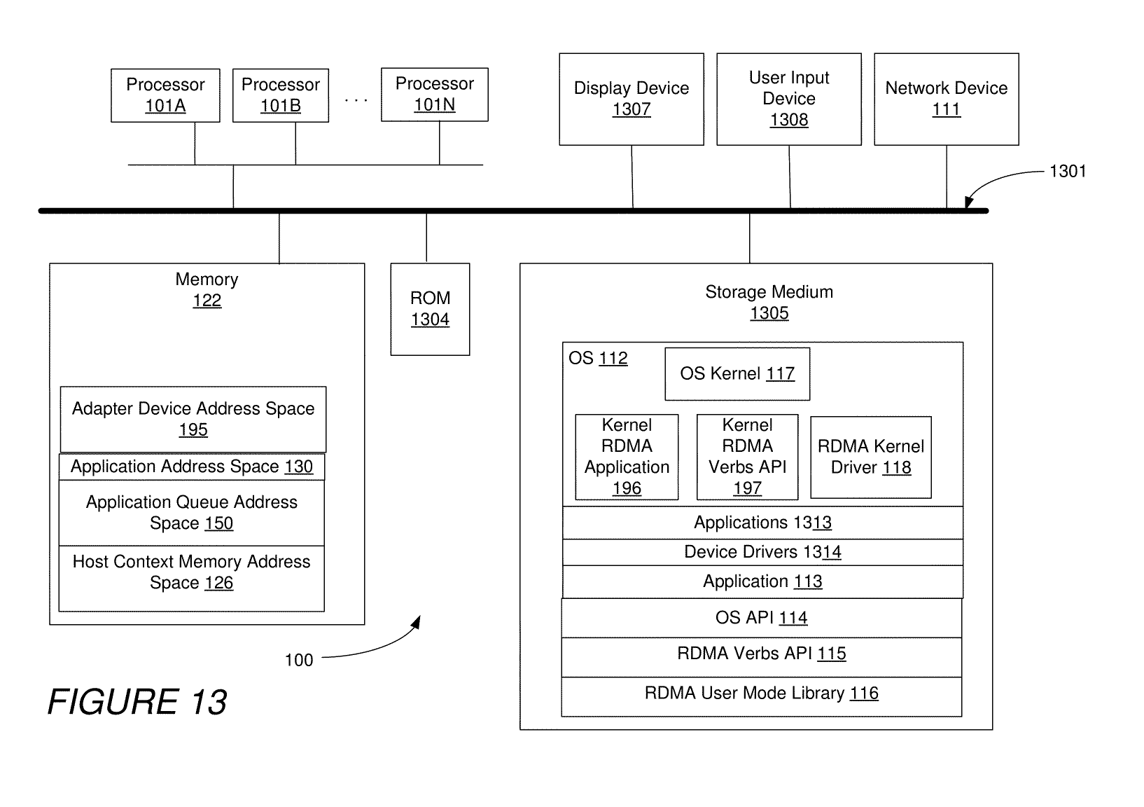

FIG. 13 is an architecture diagram of the RDMA system 100. In the example embodiment, the RDMA system 100 is a server device.

The bus 1301 interfaces with the processors 101A-101N, the main memory (e.g., a random access memory (RAM)) 122, a read only memory (ROM) 1304, a processor-readable storage medium 1305, a display device 1307, a user input device 1308, and the network device 111 of FIG. 1.

The processors 101A-101N may take many forms, such as ARM processors, X86 processors, and the like.

In some implementations, the RDMA system 100 includes at least one of a central processing unit (processor) and a multi-processor unit (MPU).

The processors 101A-101N and the main memory 122 form a host processing unit. In some embodiments, the host processing unit includes one or more processors communicatively coupled to one or more of a RAM, ROM, and machine-readable storage medium; the one or more processors of the host processing unit receive instructions stored by the one or more of a RAM, ROM, and machine-readable storage medium via a bus; and the one or more processors execute the received instructions. In some embodiments, the host processing unit is an ASIC (Application-Specific Integrated Circuit). In some embodiments, the host processing unit is a SoC (System-on-Chip). In some embodiments, the host processing unit includes one or more of the RDMA Kernel Driver, the Kernel RDMA Verbs API, the Kernel RDMA Application, the RDMA Verbs API, and the RDMA User Mode Library.

The network adapter device 111 provides one or more wired or wireless interfaces for exchanging data and commands between the RDMA system 100 and other devices, such as a remote RDMA system. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system 112, application programs 1313, and device drivers 1314) are loaded into the memory 122 from the processor-readable storage medium 1305, the ROM 1304 or any other storage location. During execution of these software programs, the respective machine-executable instructions are accessed by at least one of processors 101A-101N via the bus 1301, and then executed by at least one of processors 101A-101N. Data used by the software programs are also stored in the memory 122, and such data is accessed by at least one of processors 101A-101N during execution of the machine-executable instructions of the software programs.

The processor-readable storage medium 1305 is one of (or a combination of two or more of) a hard drive, a flash drive, a DVD, a CD, a flash storage, a solid state drive, a ROM, an EEPROM and the like. The processor-readable storage medium 1305 includes software programs 1313, device drivers 1314, and the operating system 112, the application 113, the OS API 114, the RDMA Verbs API 115, and the RDMA user mode library 116 of FIG. 1B The OS 112 includes the OS kernel 117, the RDMA kernel driver 118, the Kernel RDMA Application 196, and the Kernel RDMA Verbs API 197 of FIG. 1B.

FIG. 14 is an architecture diagram of the RDMA network adapter device 111 of the RDMA system 100.

In the example embodiment, the RDMA network adapter device 111 is a network communication adapter device that is constructed to be included in a server device. In some embodiments, the RDMA network device is a network communication adapter device that is constructed to be included in one or more of different types of RDMA systems, such as, for example, client devices, network devices, mobile devices, smart appliances, wearable devices, medical devices, storage devices, sensor devices, vehicles, and the like.

The bus 1401 interfaces with a processor 1402, a random access memory (RAM) 170, a processor-readable storage medium 1405, a host bus interface 1409 and a network interface 1460.

The processor 1402 may take many forms, such as, for example, a central processing unit (processor), a multi-processor unit (MPU), an ARM processor, and the like.

The processor 1402 and the memory 170 form an adapter device processing unit. In some embodiments, the adapter device processing unit includes one or more processors communicatively coupled to one or more of a RAM, ROM, and machine-readable storage medium; the one or more processors of the adapter device processing unit receive instructions stored by the one or more of a RAM, ROM, and machine-readable storage medium via a bus; and the one or more processors execute the received instructions. In some embodiments, the adapter device processing unit is an ASIC (Application-Specific Integrated Circuit). In some embodiments, the adapter device processing unit is a SoC (System-on-Chip). In some embodiments, the adapter device processing unit includes the firmware 120. In some embodiments, the adapter device processing unit includes the RDMA Driver 1422. In some embodiments, the adapter device processing unit includes the RDMA stack 1420. In some embodiments, the adapter device processing unit includes the software transport interfaces 1450.

The network interface 1460 provides one or more wired or wireless interfaces for exchanging data and commands between the network communication adapter device 111 and other devices, such as, for example, another network communication adapter device. Such wired and wireless interfaces include, for example, a Universal Serial Bus (USB) interface, Bluetooth interface, Wi-Fi interface, Ethernet interface, Near Field Communication (NFC) interface, and the like.

The host bus interface 1409 provides one or more wired or wireless interfaces for exchanging data and commands via the host bus 1301 of the RDMA system 100. In the example implementation, the host bus interface 1409 is a PCIe host bus interface.

Machine-executable instructions in software programs are loaded into the memory 170 from the processor-readable storage medium 1405, or any other storage location. During execution of these software programs, the respective machine-executable instructions are accessed by the processor 1402 via the bus 1401, and then executed by the processor 1402. Data used by the software programs are also stored in the memory 170, and such data is accessed by the processor 1402 during execution of the machine-executable instructions of the software programs.

The processor-readable storage medium 1405 is one of (or a combination of two or more of) a hard drive, a flash drive, a DVD, a CD, a flash storage, a solid state drive, a ROM, an EEPROM and the like. The processor-readable storage medium 1405 includes the firmware 120. The firmware 120 includes software transport interfaces 1450, an RDMA stack 1420, an RDMA driver 1422, a TCP/IP stack 1430, an Ethernet NIC driver 1432, a Fibre Channel stack 1440, an FCoE (Fibre Channel over Ethernet) driver 1442, a NIC send queue processing module 1461, and a NIC receive queue processing module 1462.

The memory 170 includes the adapter device context memory address space 181. In some implementations, the memory 170 includes the adapter device send queues 171 and 173, the adapter device receive queues 172 and 174, the adapter device completion queue 175.

In the example implementation, RDMA verbs are implemented in software transport interfaces 1450. In the example implementation, the RDMA protocol stack 1420 is an INFINIBAND protocol stack. In the example implementation the RDMA stack 1420 handles different protocol layers, such as the transport, network, data link and physical layers.

As shown in FIG. 14, the RDMA network device 111 is configured with full RDMA offload capability, which means that both the RDMA protocol stack 1420 and the RDMA verbs (included in the software transport interfaces 1450) are implemented in the hardware of the RDMA network device 111. As shown in FIG. 14, the RDMA network device 111 uses the RDMA protocol stack 1420, the RDMA driver 1422, and the software transport interfaces 1450 to provide RDMA functionality. The RDMA network device 111 uses the Ethernet NIC driver 1432 and the corresponding TCP/IP stack 1430 to provide Ethernet and TCP/IP functionality. The RDMA network device 111 uses the Fibre Channel over Ethernet (FCoE) driver 1442 and the corresponding Fibre Channel stack 1440 to provide Fibre Channel over Ethernet functionality.

In operation, the RDMA network device 111 communicates with different protocol stacks through specific protocol drivers. Specifically, the RDMA network device 111 communicates by using the RDMA stack 1420 in connection with the RDMA driver 1422, communicates by using the TCP/IP stack 1430 in connection with the Ethernet driver 1432, and communicates by using the Fibre Channel (FC) stack 1440 in connection with the Fibre Channel over the Ethernet (FCoE) driver 1442. As described above, RDMA verbs are implemented in the software transport interfaces 1450.

While various example embodiments of the present disclosure have been described above, it should be understood that they have been presented by way of example, and not limitation. It will be apparent to persons skilled in the relevant art(s) that various changes in form and detail can be made therein. Thus, the present disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Furthermore, an Abstract is attached hereto. The purpose of the Abstract is to enable the U.S. Patent and Trademark Office and the public generally, including those who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A host device comprising:
a remote direct memory access (RDMA) network communication adapter device to provide remote direct memory access (RDMA) to a remote device;
a host processing unit that includes at least one processor constructed to read and execute instructions of at least one memory, the instructions, when executed by the host processing unit, perform processes including:
responsive to determination of an RDMA on-load event for an RDMA queue used in an RDMA connection, using at least one of a user-mode module and an operating system of the host device to provide an RDMA on-load notification to the RDMA network communication adapter device notifying the adapter device of the determination of the on-load event for the RDMA queue, the determination being performed by at least one of the user-mode module and the operating system; and
during processing of an RDMA transaction of the RDMA queue in a case where the RDMA on-load event is determined, using the operating system to perform at least one RDMA sub-process of the RDMA transaction.

2. The host device of claim 1,
wherein the RDMA queue is at least one of a send queue (SQ) and a receive queue (RQ) of an RDMA Queue Pair (QP),
wherein the RDMA transaction includes at least one of an RDMA transmission and an RDMA reception, and
wherein the RDMA connection is at least one of a reliable connection (RC) and an unreliable connection (UC).

3. The host device of claim 1, wherein at least one of the user-mode module and the operating system determines the on-load event for the RDMA queue based on at least one of parameters provided during creation of the RDMA queue, operating system events, adapter device events, properties of an application associated with the RDMA transaction, network traffic properties, properties of packets transmitted by the network communication adapter device, and properties of packets received by the network communication adapter device.

4. The host device of claim 1, wherein at least one of the user-mode module and the operating system provides the RDMA on-load notification via at least one of an interrupt and an RDMA work request.

5. The host device of claim 1, wherein responsive to the RDMA on-load notification, the adapter device moves context information for the RDMA queue from a memory of the adapter device to a main memory of the host device and changes ownership of the context information from the adapter device to the operating system.

6. The host device of claim 5, wherein in the case where the RDMA on-load event is determined, the operating system performs the at least one RDMA sub-process based on the context information.

7. The host device of claim 5, wherein the context information of the RDMA queue includes at least one of signaling journals, acknowledgment (ACK) timers for the RDMA queue, PSN information, incoming read context, outgoing read context and state information related to protocol processing.

8. The host device of claim 1, wherein the instructions further include:
responsive to determination of an RDMA off-load event for the RDMA queue, using at least one of the user-mode module and the operating system to provide an RDMA off-load notification to the adapter device notifying the adapter device of the determination of the off-load event for the RDMA queue, the determination being performed by at least one of the user-mode module and the operating system;
during processing of the RDMA transaction of the RDMA queue in a case where the RDMA off-load event is determined, using the adapter device to perform the at least one RDMA sub-process,
wherein at least one of the user-mode module and the operating system determines the off-load event for the RDMA queue based on at least one of parameters provided during creation of the RDMA queue, operating system events, adapter device events, properties of an application associated with the RDMA transaction, network traffic properties, properties of packets transmitted by the network communication adapter device, and properties of packets received by the network communication adapter device, and
wherein at least one of the user-mode module and the operating system provides the RDMA off-load notification via at least one of an interrupt and an RDMA Work Request.

9. The host device of claim 8, wherein responsive to the RDMA off-load notification, the adapter device moves context information for the RDMA queue from a main memory of the host device to a memory of the adapter device and changes ownership of the context information from the operating system to the adapter device.

10. The host device of claim 9,
wherein in the case where the RDMA off-load event is determined, the adapter device performs the at least one RDMA sub-process based on the context information,
wherein the host device includes a host processing unit that is constructed to dynamically select one of on-loading and off-loading based on determination of one of an on-load event and an off-load event.

11. An adapter device comprising:
a storage medium constructed to store adapter device firmware instructions; and
an adapter device processing unit that includes at least one processor constructed to read and execute the firmware instructions, the firmware instructions, when executed by the adapter device processing unit, perform processes including:
responsive to an RDMA on-load notification for an RDMA queue used in an RDMA connection, moving context information for the RDMA queue from a memory of the adapter device to a main memory of an RDMA-enabled host device and changing ownership of the context information from the adapter device to an operating system of the RDMA-enabled host device,
wherein at least one of a user-mode module and the operating system provides the RDMA on-load notification responsive to at least one of the user-mode module's and the operating system's determination of an RDMA on-load event for the RDMA queue, and
wherein during processing of an RDMA transaction of the RDMA queue in a case where the RDMA on-load event is determined, the operating system performs at least one RDMA sub-process of the RDMA transaction,
wherein the adapter device is configured for remote direct memory access (RDMA) network communication.

12. The adapter device of claim 11,
wherein the RDMA queue is at least one of a send queue (SQ) and a receive queue (RQ) of an RDMA queue pair (QP),
wherein the RDMA transaction includes at least one of an RDMA transmission and an RDMA reception,
wherein the RDMA connection is at least one of a reliable connection (RC) and an unreliable connection (UC),
wherein at least one of the user-mode module and the operating system determines the on-load event for the RDMA queue based on at least one of parameters provided during creation of the RDMA queue, properties of an application associated with the RDMA transaction, network traffic properties, properties of packets transmitted by the network communication adapter device, and properties of packets received by the network communication adapter device,
wherein at least one of the user-mode module and the operating system provides the RDMA on-load notification via at least one of an interrupt and an RDMA work request, and
wherein in the case where the RDMA on-load event is determined, the operating system performs the at least one RDMA sub-process based on the context information.

13. The adapter device of claim 11, wherein the instructions perform processes further including:
responsive to an RDMA off-load notification for the RDMA queue, moving context information for the RDMA queue from the main memory of the RDMA-enabled host device to the memory of the adapter device and changing ownership of the context information from the operating system to the adapter device,
wherein at least one of the user-mode module and the operating system of the RDMA-enabled host device provides the RDMA off-load notification responsive to at least one of the user-mode module's and the operating system's determination of an RDMA off-load event for the RDMA queue,
wherein during processing of the RDMA transaction of the RDMA queue in a case where the RDMA off-load event is determined, the adapter device performs the at least one RDMA sub-process,
wherein at least one of the user-mode module and the operating system determines the off-load event for the RDMA queue based on at least one of parameters provided during creation of the RDMA queue, operating system events, adapter device events, properties of an application associated with the RDMA transaction, network traffic properties, properties of packets transmitted by the network communication adapter device, and properties of packets received by the network communication adapter device,
wherein at least one of the user-mode module and the operating system provides the RDMA off-load notification via at least one of an interrupt and an RDMA Work Request, and
wherein in the case where the RDMA off-load event is determined, the adapter device performs the at least one RDMA sub-process based on the context information.

14. The adapter device of claim 11, wherein the context information of the RDMA queue includes at least one of signaling journals, acknowledgment (ACK) timers for the RDMA queue, PSN information, incoming read context, outgoing read context and state information related to protocol processing.

15. A method comprising:
responsive to determination of a remote direct memory access (RDMA) on-load event for an RDMA queue used in an RDMA connection, generating an RDMA on-load notification;
responsive to generation of the notification:
moving context information for the RDMA queue from an adapter device to an RDMA-enabled host device, and
changing ownership of the context information from the adapter device to an operating system of the RDMA-enabled host device.
during processing of an RDMA transaction of the RDMA queue in a case where the RDMA on-load event is determined, using the operating system to perform at least one RDMA sub-process of the RDMA transaction.

16. The method of claim 15,
wherein the generation of the notification further comprises providing the notification to the adapter device,
wherein at least one of a user-mode module and the operating system of the host device provides the RDMA notification to the adapter device,
wherein the host device includes the adapter device,
wherein the determination of the on-load event is performed by at least one of the user-mode module and the operating system.

17. The method of claim 16, further comprising:
responsive to an RDMA off-load notification for the RDMA queue, moving context information for the RDMA queue from the host device to the adapter device and changing ownership of the context information from the operating system to the adapter device,
during processing of the RDMA transaction in a case where the RDMA off-load event is determined, the adapter device performs the at least one RDMA sub-process.

18. The method of claim 17, wherein on-load event and the off-load event for the RDMA queue are each determined based on at least one of: parameters provided during creation of the RDMA queue, operating system events, adapter device events, properties of an application associated with the RDMA transaction, network traffic properties, properties of packets transmitted by the network communication adapter device, and properties of packets received by the network communication adapter device.

19. The method of claim 18,
wherein in the case where the RDMA off-load event is determined, the adapter device performs the at least one RDMA sub-process based on the context information, and
wherein the on-loading and off-loading is dynamically selected based on determination of one of an on-load event and an off-load event.

20. (canceled)
